(19) United States
(12) Patent Application Publication
(10) Pub. No.: US 2003/0031371 A1
(43) Pub. Date: Feb. 13, 2003

(54) Image encoding apparatus and image decoding apparatus

(76) Inventors: Shinichi Kato, Kanagawa (JP); Naoki Ito, Tokyo (JP)

Correspondence Address: FITZPATRICK CELLA HARPER & SCINTO, 30 ROCKEFELLER PLAZA, NEW YORK, NY, 10112, US

(21) Appl. No.: 10/206,102

(22) Filed: Jul. 29, 2002

(30) Foreign Application Priority Data
Aug. 2, 2001 (JP) 2001-235180
Nov. 5, 2001 (JP) 2001-339864

(51) Int. Cl. G06K 9/36

(52) U.S. Cl. 382/239

(57) ABSTRACT

This invention has as its object to efficiently compress a mixed image which includes both natural and non-natural images upon encoding and decoding image data.

To achieve this object, in an image encoding apparatus according to this invention, a line buffer (101) segments image data (131) input from an image scanner (130) for inputting image data into a plurality of regions, a discrimination unit (120) discriminates the ratio of regions each having a predetermined nature to the image data (131), a quantization matrix selector (121) selects a quantization matrix used to compress the region on the basis of this ratio, an image data encoder (103) compresses the region using the selected quantization matrix, and an attribute flag encoder (102) compresses information which helps the decoding side estimate a quantization matrix used to encode the region.

### FIELD OF THE INVENTION

This invention relates to encoding and decoding of image data.

### BACKGROUND OF THE INVENTION

As a conventional color still image compression method, a JPEG method that exploits discrete cosine transformation and a method that exploits Wavelet transformation are prevalently used. Such encoding method uniformly encodes the entire image.

A natural image such as a photo or the like suffers relatively slight deterioration of image quality even when such image is encoded. On the other hand, a non-natural image such as text, computer graphics, or the like suffers tremendous deterioration of image quality when such image is encoded.

Efficient encoding of a composite image that includes both a photo image and text image will be examined below.

In consideration of the deterioration characteristics of image quality upon encoding depending on the types of images, high compression efficiency cannot be assured if the entire image is uniformly encoded as in the conventional method.

Hence, different quantization steps upon encoding may be set for text and photo regions. For example, a coarse quantization step is set for a photo region where deterioration of image quality is relatively inconspicuous, and a fine quantization step is set for a text or computer graphics region where deterioration of image quality is relatively conspicuous.

However, in order to implement such process, the positions of natural and non-natural image regions in an image must be discriminated.

In order to designate a region for which a different quantization step is to be set, a method of designating a rectangular region that includes the entire photo region by dragging a mouse by the user may be used. However, since this method simultaneously designates the entire photo region, the quantization step can only be switched for considerably large areas. When such large region is designated, designation errors may be generated. Also, the user must designate regions in every processes, resulting in poor operability.

Furthermore, in order to improve the compression efficiency while maintaining a high image quality level, it is hardly adequate to only switch the quantization step by discriminating natural and non-natural image regions. For example, the user requires different image quality levels even for non-natural images, i.e., an image that attaches an importance on image quality (e.g., computer graphics image) and an image that attaches an importance on the compression ratio rather than image quality (e.g., a business document). That is, different image quality levels are required even for images having an identical attribute depending on the types of images (image formats). For this reason, when a computer graphics image and business document are processed using the same quantization matrix, although they both are non-natural images, image quality is unsatisfactory for a user who processed a computer graphics image, and the compression ratio is unsatisfactory for a user who processed a business document.

### SUMMARY OF THE INVENTION

The present invention has been made in consideration of the above problems, and has as its objects:

(1) to efficiently compress a mixed image which includes both natural and non-natural images, and to improve image quality after compression compared to the conventional method;

(2) to improve image quality after compression compared to the conventional method by reducing the extraction areas of natural and non-natural images to be smaller than the conventional method;

(3) to reduce the load on extraction processes of natural and non-natural images;

(4) to achieve both maintenance of image quality and improvement in compression ratio in a non-natural image by executing image compression and decoding processes suitable not only for the attribute of an image but also for the type of image (image format); and

(5) to provide an image processing apparatus and method that can solve the aforementioned problems and a computer program which can implement them.

In order to achieve the above objects (1) to (3) and (5), an image encoding apparatus according to the present invention comprises the following arrangement.

That is, an image encoding apparatus comprises input means for inputting image data, discrimination means for discriminating, for each of a plurality of regions obtained by segmenting the image data input from the input means, the number of pixels which are included in the region and have a predetermined nature, selection means for selecting an encoding method used in compression of that region on the basis of the number of pixels obtained by the discrimination means, first compression means for compressing the region by the encoding method selected by the selection means, and second compression means for compression information which can help specify the encoding method used by the first compression means.

The predetermined nature indicates, e.g., natures of natural and non-natural images.

Note that a natural image indicates image data such as a photo or the like in a narrow sense, but indicates an image, in which deterioration of image quality is relatively inconspicuous even when a high compression ratio is set, in a broad sense. On the other hand, a non-natural image indicates an artificial image represented by text, thin lines, print halftone dots, or computer graphics in a narrow sense, but an image, in which deterioration of image quality is relatively conspicuous when a high compression ratio is set, in a broad sense. Therefore, if deterioration of image quality is inconspicuous upon compression at a high compression ratio, even a computer graphics image may be classified to a natural image of the present invention. Also, if deterioration of image quality is conspicuous upon compression at a high compression ratio, even a photo image may be classified into a non-natural image of the present invention.

The arrangement of the discrimination means is not particularly limited as long as it can discriminate the state of a region. For example, the discrimination means may have an arrangement for discriminating if each of a plurality of regions, which form the image data input by the input means, is a region of a first type, a quality of which becomes not more than a predetermined quality if the region is compressed at a predetermined compression ratio, or is a region of a second type, a quality of which exceeds the predetermined quality if the region is compressed at the predetermined compression ratio.

Note that the type is information indicating the state of each region, and any kinds of information may be used as long as they can help the selection means select an appropriate encoding method. Information for each region or pixel may be used.

Furthermore, the arrangement of the selection means is not particularly limited as long as it can select an appropriate encoding method in accordance with the state of a region. For example, the selection means may have an arrangement for selecting an encoding method used in compression of the region on the basis of the type of each region discriminated by the discrimination means.

In order to achieve the objects (4) and (5), an image encoding apparatus of the present invention comprises the following arrangement.

That is, an image encoding apparatus comprises determination means for determining an image format of an input image, attribute discrimination means for discriminating an attribute of the image, quantization coefficient selection means for selecting quantization coefficients used to encode the image on the basis of the attribute discriminated by the attribute discrimination means, and the image format determined by the determination means, and encoding means for encoding the image on the basis of the quantization coefficients selected by the quantization coefficient selection means.

Since the encoding method of the present invention is a novel one, the decoding side requires a novel arrangement.

Hence, according to the present invention, an image decoding apparatus for decoding encoded data, which is obtained by encoding a plurality of regions that form image data as units, to obtain the image data, comprises storage means for storing the encoded data, first decoding means for decoding information associated with a type of region to be decoded from the encoded data stored in the storage means, discrimination means for discriminating an encoding method used on the encoding side on the basis of the information associated with the type of region decoded by the first decoding means, selection means for selecting a decoding method used to decode the region on the basis of the information associated with the type of region discriminated by the discrimination means, and second decoding means for decoding the region by the decoding method selected by the selection means.

Note that the arrangement of the discrimination means is not particularly limited as long as it can estimate the encoding method used on the encoding side. In this sense, the discrimination means can be expressed as estimation means. For example, the discrimination means may have an arrangement for discriminating, based on the information associated with the type of region decoded by the first decoding means, if the region is a region of a first type, a quality of which becomes not more than a predetermined quality if the region is compressed at a predetermined compression ratio, or is a region of a second type, a quality of which exceeds the predetermined quality if the region is compressed at the predetermined compression ratio.

If the information associated with the type of region is information for each pixel, the state of the region can be estimated by statistically processing such information. The information associated with the type of region may use information that directly specifies the encoding method. For example, code information that can classify the encoding method may be used. Note that the encoding side may directly designate a decoding method.

The selection means may select the encoding method by using a function f(x) that indicates an encoding coefficient when the ratio is x. In this case, the function f(x) sets a high compression ratio upon encoding when the ratio of natural images is high, and sets a low compression ratio upon encoding when the ratio of non-natural images is high.

Furthermore, according to the present invention, an image decoding apparatus for decoding encoded data, which is obtained by encoding an image with a predetermined image format, and information associated with an attribute of the image, to obtain the image, comprises first decoding means for decoding the encoded data to obtain the information associated with the attribute of the image, attribute discrimination means for discriminating an attribute of the image on the basis of the information decoded by the first decoding means, dequantization coefficient selection means for reading out the image format of the image, and selecting dequantization coefficients used to decode the encoded data to obtain the image on the basis of the image format and the attribute of the image discriminated by the attribute discrimination means, and second decoding means for decoding the image on the basis of the dequantization coefficients selected by the dequantization coefficient selection means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram of an image processing apparatus according to the first embodiment;

FIGS. 2A and 2B are block diagrams for explaining an image encoder using DCT;

FIG. 3 is a block diagram for explaining an attribute flag data encoder using a runlength;

FIG. 4A is a view for explaining switching of quantization matrices for respective tiles;

FIG. 4B is a view for explaining switching of quantization matrices for respective tiles;

FIG. 4C is a view for explaining switching of quantization matrices for respective tiles;

FIG. 4D is a view for explaining switching of quantization matrices for respective tiles;

FIG. 5 is a graph showing the ratios of text and photo attributes;

FIG. 6 is a flow chart for executing an attribute discriminating process in the image processing apparatus according to the first embodiment;

FIG. 7 is a block diagram of an image processing apparatus according to the second embodiment;

FIG. 8 is a block diagram of a dequantization matrix selector according to the second embodiment;

FIG. 9 is a view for explaining the data structure in the second embodiment;

FIG. 10 is a block diagram showing the arrangement of a network system according to the third embodiment;

FIG. 11 is a side sectional view of an image processing apparatus;

FIG. 12 is a functional block diagram of an image processing apparatus according to the fourth embodiment;

FIGS. 13A and 13B are flow charts for executing an encoding process in the image processing apparatus according to the fourth embodiment;

FIGS. 14A and 14B are block diagrams respectively showing the internal arrangements of an image data encoder and image data decoder in the image processing apparatus according to the fourth embodiment;

FIG. 15 is a flow chart showing the flow of the selection process of an encoding quantization matrix selector in the image processing apparatus according to the fourth embodiment;

FIG. 16 is a flow chart showing the flow of the selection process of a decoding quantization matrix selector in the image processing apparatus according to the fourth embodiment;

FIG. 17 is a selection table of quantization matrices used by the encoding and decoding quantization matrix selectors in the image processing apparatus according to the fourth embodiment;

FIGS. 18A and 18B show examples of quantization matrixes used in the image processing apparatus according to the fourth embodiment;

FIG. 19 shows the data structure when image data and attribute flag data which are compressed by the image processing apparatus according to the fourth embodiment are stored in an encoding compression memory;

FIG. 20 shows the data structure when image data and attribute flag data which are compressed by an image processing apparatus according to the fifth embodiment are stored in an encoding compression memory; and

FIG. 21 is a block diagram showing functions of an image processing apparatus according to another embodiment.

### DETAILED DESCRIPTION OF THE PREFERRED EMBODIMENTS

Preferred embodiments of the present invention will now be described in detail in accordance with the accompanying drawings.

[First Embodiment]

An outline of the operation of this embodiment is as follows. Image data input from a scanner is segmented into a plurality of tiles using a line buffer. The ratio of titles with a text attribute contained in the image data is calculated. Based on this ratio, a first encoding method used for tiles with the text attribute or a second encoding method used for tiles with a photo attribute is selected. An image data encoder sequentially compresses the tiles by the selected encoding method. Also, information indicating the encoding method used on the encoding side is compressed for each tile. In the structure of the encoded image data, information indicating the encoding method is set in a header field, and compressed data obtained by compressing respective tiles follow. This embodiment will be explained below using the accompanying drawings.

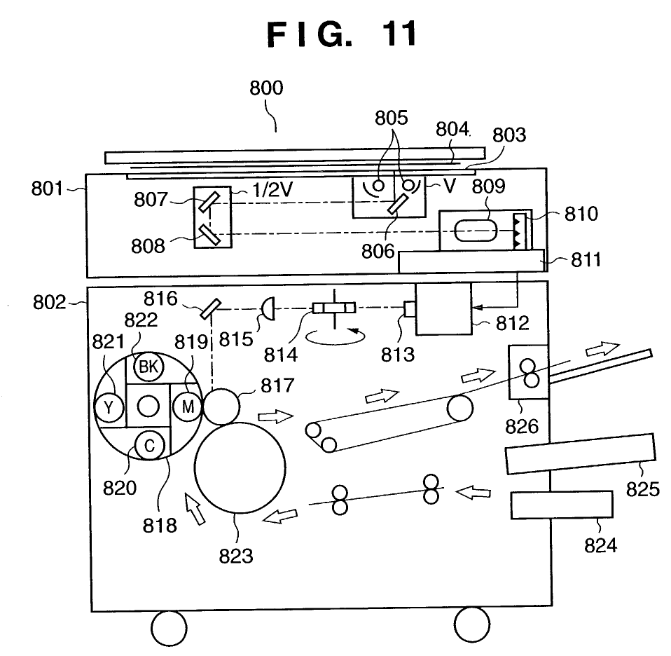

FIG. 11 is a side sectional view of a multi-functional digital image input/output apparatus (to be referred to as an image processing apparatus hereinafter) according to each embodiment.

An image processing apparatus 800 is mainly constituted by an image reader section 801 for reading a document image, and a printer section 802 for reproducing image data read by the image reader section 801.

The image reader section 801 reads a document image at a resolution of 400 dpi (dots/inch), and executes a digital signal process of the read image. The printer section 802 prints out a full-color image corresponding to the document image read by the image reader section 801 on a designated paper sheet.

In the image reader section 801, a document 804 placed on a document table glass (to be referred to as a platen hereinafter) 803 is irradiated with light emitted by a lamp 805. Light reflected by the document is guided by mirrors 806, 807, and 808, and is focused by a lens 809, thus forming an image on a 3-line sensor (to be referred to as a CCD hereinafter) 810. Red (R), green (G), and blue (B) components of full-color information obtained by converting an optical image into an electrical signal by the CCD are sent to a signal processing unit 811. Note that a carriage that fixes the lamp 805 and mirror 806, and the mirrors 807 and 808 respectively move at velocities v and ½ v in a direction perpendicular to the electrical scan (main scan) direction of the line sensor, thus scanning the entire surface of the document (sub-scan).

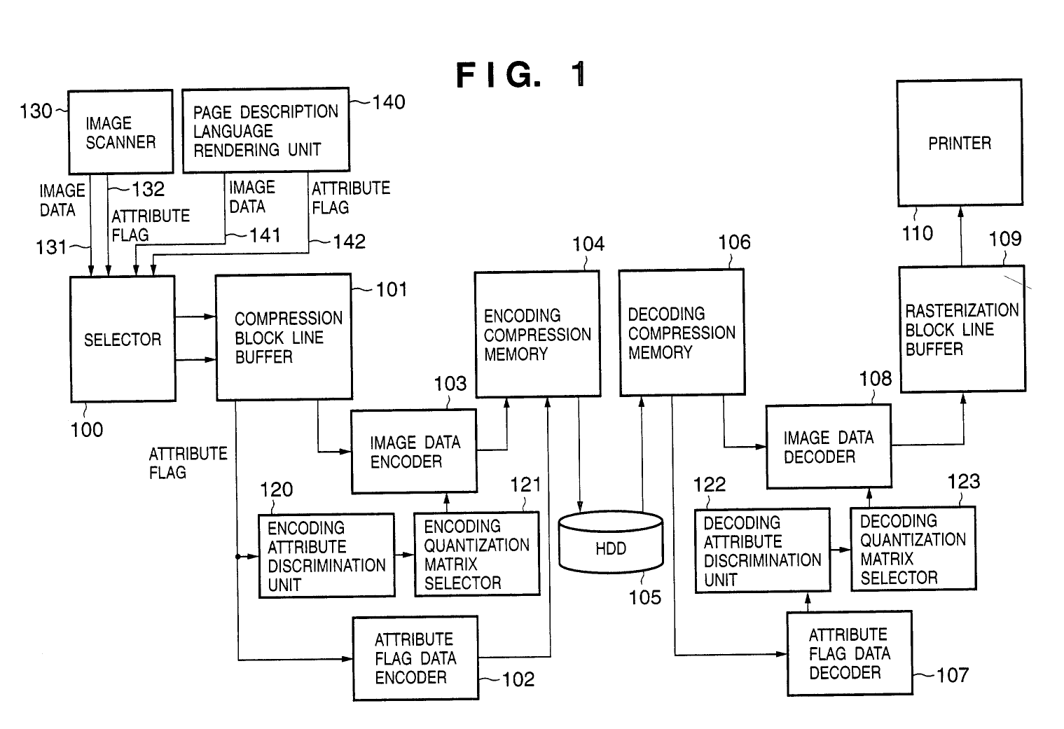

In the signal processing unit 811, the read image signal is electrically processed to undergo an image process (image encoding/decoding process; to be described later with reference to FIG. 1), and is then decomposed into magenta (M), cyan (C), yellow (Y), and black (Bk) components. Note that the signal processing unit 811 can apply the same image process (image encoding/decoding process) not only to an image signal read by the image reader section 801 but also to an image signal received from an external computer (not shown).

M, C, Y, and Bk image signals are sent to a laser driver 812. The laser driver 812 modulates and drives a semiconductor laser 813 in accordance with the received image signals. A laser beam scans the surface of a photosensitive drum 817 via a polygonal mirror 814, f-θ lens, and mirror 816. Reference numeral 818 denotes a rotary developer, which comprises magenta, cyan, yellow, and black developing units 819, 820, 821, and 822. The four developing units alternately contact the photosensitive drum 817 to develop a latent image formed on the photosensitive drum with corresponding toner. Reference numeral 823 denotes a transfer drum. A paper sheet fed from a paper cassette 824 or 825 is wound around this transfer drum 823, thus transferring each toner image formed on the photosensitive drum onto the paper sheet.

In this way, after four, i.e., M, C, Y, and Bk toner images are transferred in turn, the paper sheet passes through a fixing unit 826, and is exhausted after the toner images are fixed on it.

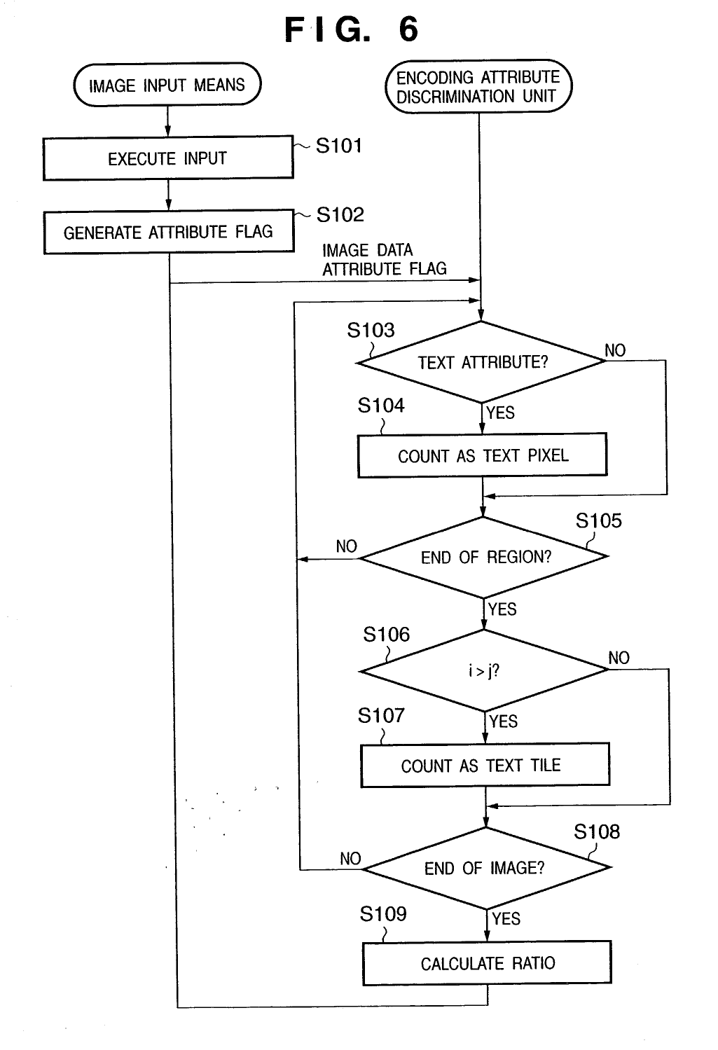

FIG. 1 is a block diagram showing details of the signal processing unit 811 which has image input, storage, and output means according to the present invention. FIG. 6 is a flow chart of this embodiment.

Referring to FIG. 1, reference numeral 100 denotes a selector for switching image input systems; 101, a compression block line buffer; 102, an attribute flag data encoder; 103, an image data encoder; 104, an encoding compression memory; 105, a large-capacity external storage device (HDD); 106, a decoding compression memory; 107, an attribute flag data decoder; 108, an image data decoder; and 109, a rasterization block line buffer. Also, reference numeral 110 denotes an I/F with the aforementioned printer section 802.

Upon receiving an image data input instruction from a control means (not shown) (S100), an image input means inputs image data (S101). The image input means includes an image scanner 130 which receives an image signal from the aforementioned image reader section 801, a page description language (PDL) rendering unit 140 for receiving an image signal from an external computer (not shown), and the like. The selector 100 switches the image input means according to the use purpose.

The image scanner 130 includes a known image region separation processor (not shown). This image region separation processor discriminates if a read pixel has a text or photo attribute. For example, if a pixel which forms a black character in a document image is found, the processor sets and outputs an attribute flag “1” of this pixel; otherwise, the processor outputs an attribute flag “0” (S102). In this way, the selector 100 receives image data 131 and attribute flags 132.

On the other hand, the PDL rendering unit 140 interprets PDL commands to generate a print image. At this time, the unit 140 identifies a black character pixel with reference to information indicating the type of command as in the image scanner 130, and generates an attribute flag. In this case, the selector 100 receives image data 141 and attribute flags 142.

Note that the attribute flags 132 and 142 are not limited to ones which indicate black character pixels. For example, multi-bit information which indicates various attributes such as a color character region, halftone dot region, vector graphics region, and the like may be used as an attribute flag.

The compression block line buffer 101 segments image data into a plurality of tiles. After that, image data for respective tiles are input to the image data encoder 103. Also, the attribute flags for respective pixels are input to an encoding attribute discrimination unit 120 and the attribute flag data encoder 102.

Assume that each tile has a size of M pixels×N pixels (M and N are natural numbers) for the sake of simplicity. Encoding of color information using discrete cosine transformation encoding (JPEG) and that of attribute flag data using runlength encoding are executed for each tile, i.e., for M×N pixels.

When discrete cosine transformation encoding is applied as an encoding method, M and N must be integer multiples of a window size. In this embodiment, if the window size for compression is 8×8 pixels, and M=N=32, a tile consisting of 32×32 pixels is further broken up into 16 blocks each having 8×8 pixels, and JPEG compression is done for 8×8 pixels. In the following description, M=N=32, but the present invention is not limited to these specific values.

Also, discrete cosine transformation encoding and runlength encoding will be exemplified as examples of compression methods. However, the present invention is not limited to these specific methods, and other compression methods may be used.

The encoding attribute discrimination unit 120 checks if each of the attribute flags of 32×32 pixels input from the compression block line buffer indicates a text attribute (S103). Note that the attribute flag is assigned to each pixel. Furthermore, in this embodiment, the attribute flag of each tile is determined. This is because encoding is done for each tile in this embodiment. Hence, the number of pixels per tile, which are determined to have text attributes, is counted (S104, S105). If the number i of pixels with the text attribute contained per tile is larger than a predetermined threshold value j, that tile is determined to be a tile with a text attribute (S105). This process is repeated for the entire image, and the number of tiles with the text attributes is counted (S107, S108). Subsequently, the ratio of tiles with the text attributes contained in one image is calculated (S109). An encoding quantization matrix selector 121 selects a quantization matrix used in encoding on the basis of this ratio, and outputs a quantization matrix selection signal to the image data encoder 103. A method of selecting quantization coefficients (quantization matrix) will be described in detail later. The image data encoder 103 quantizes 16 8×8 pixel windows contained in one tile by known DCT using the selected quantization matrix. The attribute flag data encoder 102 encodes and compresses the attribute flags of pixels contained in one tile.

Encoded data generated by the attribute flag data encoder 102 and image data encoder 103 in this way are stored as compressed attribute flag data and compressed image data in the hard disk (HDD) 105 via the encoding compression memory 104.

Upon outputting a stored image from a printer 110, the compressed image data and compressed attribute flag data stored in the hard disk (HDD) 105 are read out, and are decoded and output in the following sequence.

The attribute flag data decoder 107 reads out and decodes data for M×N pixels of the stored compressed attribute flag data. A decoding attribute discrimination unit 122 executes an attribute discrimination process on the basis of the decoding result of the attribute flag data. Since the discrimination process at that time is the same as the processes in steps S103 to S109 in FIG. 6, a description thereof will be omitted. A decoding quantization matrix selector 123 selects decoding coefficients (dequantization matrix in this embodiment) used in decoding on the basis of this discrimination result. The image data decoder 108 decodes image data for respective tiles using the decoding coefficients selected in this way, and outputs the result to the rasterization block line buffer.

The decoding attribute discrimination unit can execute the same process as in the encoding attribute discrimination unit 120. This is because the discrimination results for a given tile upon encoding and decoding become equal to each other since the attribute flag data are compressed by reversible compression such as runlength encoding free from deterioration. Therefore, even when each tile is quantized using different quantization coefficients, dequantization coefficients suitable for each tile are set upon decoding, thus obtaining correctly decoded image data.

When the encoding side encodes attribute flag data for respective tiles in place of attribute data for respective pixels, and sends the encoded attribute flag data to the decoding side, the decoding attribute discrimination unit 122 can be omitted. This is because the attribute flag data for respective tiles are data themselves to be obtained by the decoding attribute discrimination unit 122. A detailed description of such case will be given in the second embodiment.

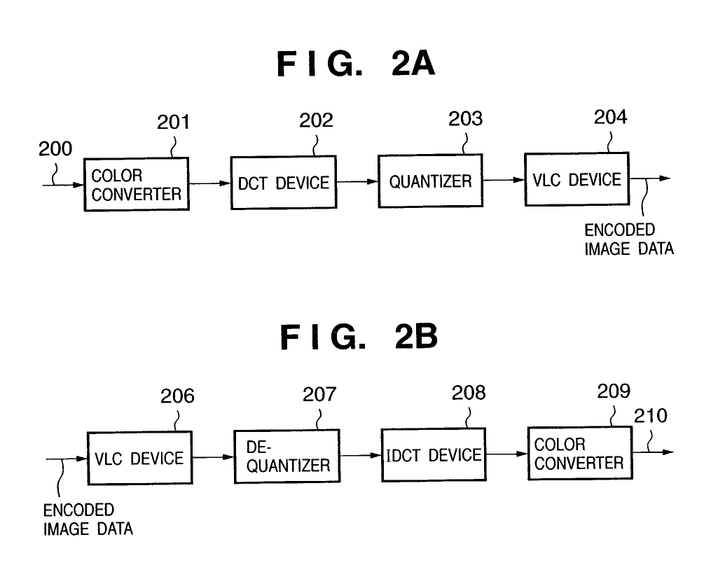

FIGS. 2A and 2B are block diagrams of the image data encoder 103 and image data decoder 108.

The image data encoder 103 includes a color converter 201, discrete cosine transformation (DCT) device 202, quantizer 203, and variable-length encoding (VLC) device 204. The image data decoder 108 includes a variable-length decoding (VLD) device 206, dequantizer 207, inverse DCT (IDCT) device 208, and color converter 209.

In FIG. 2A, an image signal 200 is input from the image input means via the compression block line buffer 101. For example, the image signal 200 includes three-color, i.e., red (R), green (G), and blue (B) 256-level signals. The color converter 201 converts R, G, and B signals into luminance and color difference signals (Y, Cb, and Cr).

The discrete cosine transformation (DCT) device 202 computes the spatial frequency transforms (DCTs) of each of the luminance and color difference signals obtained by the color converter 201 for 8×8 pixels.

The quantizer 203 quantizes DCT coefficients obtained by the DCT device 202 using the quantization matrix selected by the encoding quantization matrix selector 121, thus reducing the data size of image data.

The variable-length encoding (VLC) device 204 executes a Huffman encoding process of the quantized values obtained by the quantizer 203 to further reduce the data size of the image data, thus obtaining encoded image data.

The arrangement of the image data encoder 103 has been explained, and the compressed encoded image data is stored in the encoding compression memory 104 or large-capacity storage device (HDD) 105.

On the other hand, the encoded image data stored in the hard disk 105 is input to the VLD device 206 via the decoding compression memory 106, and undergoes Huffman decoding.

The dequantizer 207 restores data that has undergone the process in the variable-length decoding (VLD) device 206 to DCT coefficient values using the dequantization matrix selected by the decoding quantization matrix selector 123.

The IDCT (inverse DCT) device 208 computes the inverse DCTs of the DCT coefficient values obtained by the dequantizer 207 to acquire luminance and color difference signals.

The color converter 209 restores the luminance and color difference signals obtained by the IDCT device 208 to R, G, and B image signals. As a result, R, G, and B image signals 210 (color image signal) obtained by the color converter 209 of the image data decoder 108 are, e.g., printed out via the printer 110.

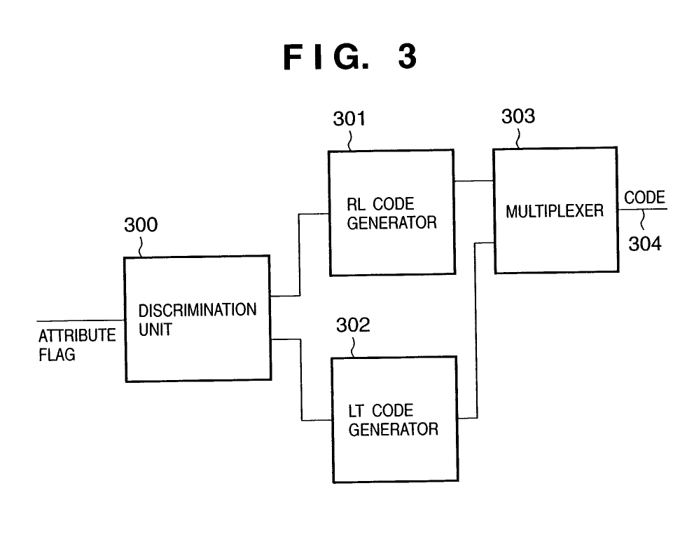

FIG. 3 is a block diagram showing the attribute flag data encoder 102 as a runlength encoder of attribute flag data.

Referring to FIG. 3, a discrimination unit 300 discriminates if the previous and current pixels have the same input attribute flag data values. If the two pixels have the same values, the unit 300 switches to send data to an RL code generator 301; otherwise, the unit 300 switches to send data to an LT code generator 302. The RL code generator 301 counts the number of times that the previous and current pixels have the same values until different data appears, and finally outputs repetitive data. The LT code generator 302 counts the number of times that the previous and current pixels have different values, and outputs a code word corresponding to the count value, and the minimum number of bits that form actual data, in correspondence with the count value. A multiplexer 303 multiplexes the output data from the RL and LT code generators 301 and 302, and outputs the multiplexed data as a code 304.

A method of switching quantization matrixes in the encoding attribute discrimination unit 120, decoding attribute discrimination unit 122, encoding quantization matrix selector 121, and decoding quantization matrix selector 123 depending on attribute flag data will be explained below.

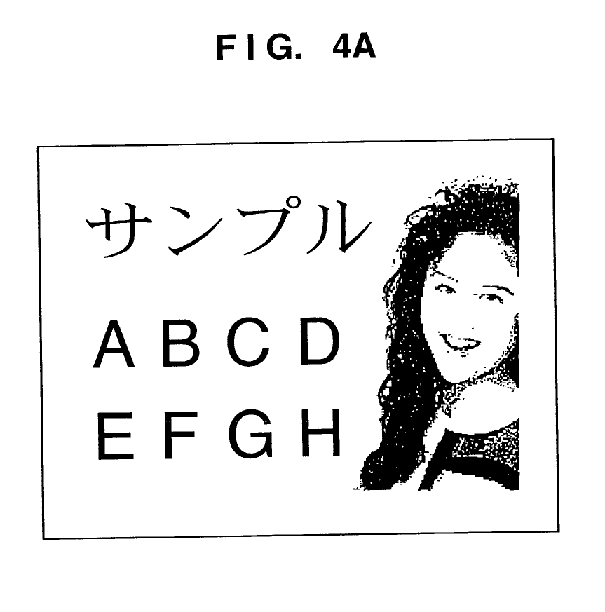

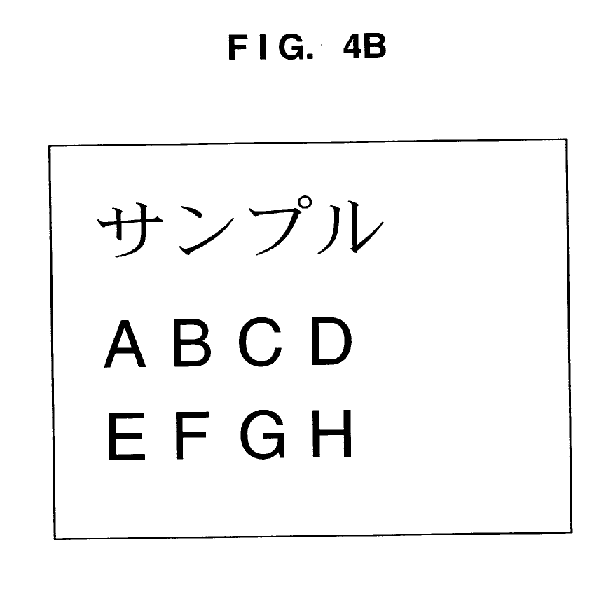

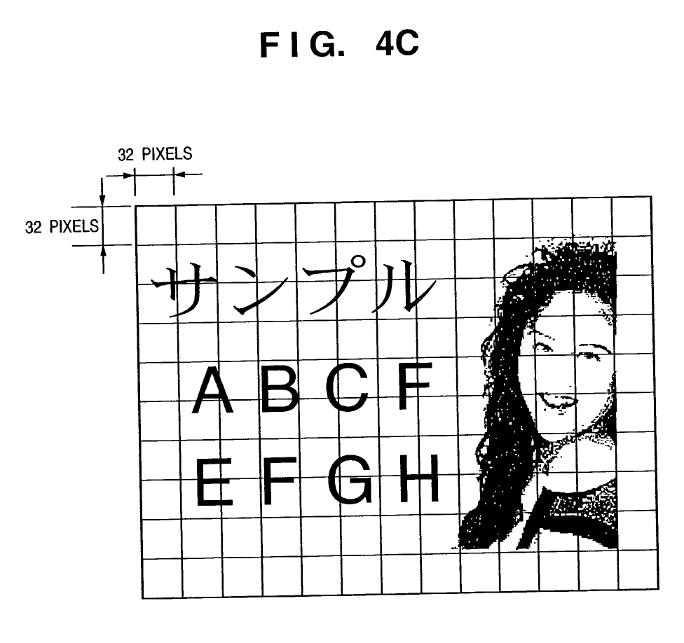

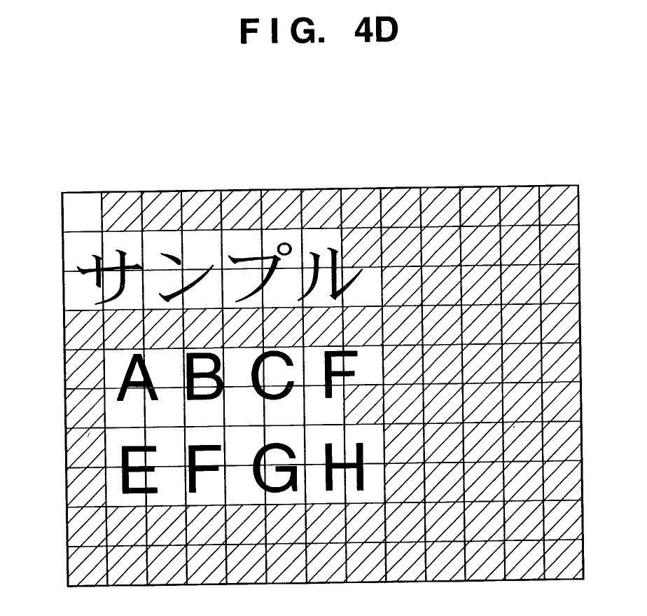

FIG. 4A shows the configuration of the entire page of an example of a document image which includes both photo and text regions. FIG. 4B shows attribute flag data generated for the document image shown in FIG. 4A. FIG. 4B illustrates an extracted text region alone.

FIG. 4C shows a state wherein the entire document image is segmented into tiles each consisting of M×N pixels (32×32 pixels in this embodiment). A quantization matrix can be set for each 32×32 pixel region.

FIG. 4D shows an example in which the tiles in FIG. 4C are classified into those with and without text attributes with reference to the attribute flag data in FIG. 4B. In FIG. 4D, hatched tiles are identified as those which do not include any characters.

It is then checked if each tile contains a character. If a tile of 32×32 pixels contains at least one pixel with a text attribute flag, it can be determined that the tile contains a character. Or the number of pixels with text attribute flag data is counted within a tile, and only when the count value exceeds a predetermined threshold value, it can be determined that the tile contains a character.

After the tiles are identified, as shown in FIG. 4D, each of the encoding quantization matrix selector 121 and decoding quantization matrix selector 123 counts the number of tiles which include characters, and that of tiles which do not include characters, and calculates the ratios of tiles which include characters and those which do not include characters with respect to the entire image.

In the example in FIG. 4D, the tiles which include characters are 42 tiles among a total of 130 tiles, and their ratio is 32%. Conversely, the ratio of tiles which do not include characters is 68%. According to these ratios, a quantization matrix suitable for the tiles which include characters, and that suitable for the tiles which do not include characters are selected from those stored in the quantizer 203 and dequantizer 207 shown in FIGS. 2A and 2B so as to encode and decode image data. That is, the quantization matrix is automatically changed in accordance with input image data, and the ratios of text and photo regions to the entire image, thus encoding and decoding image data.

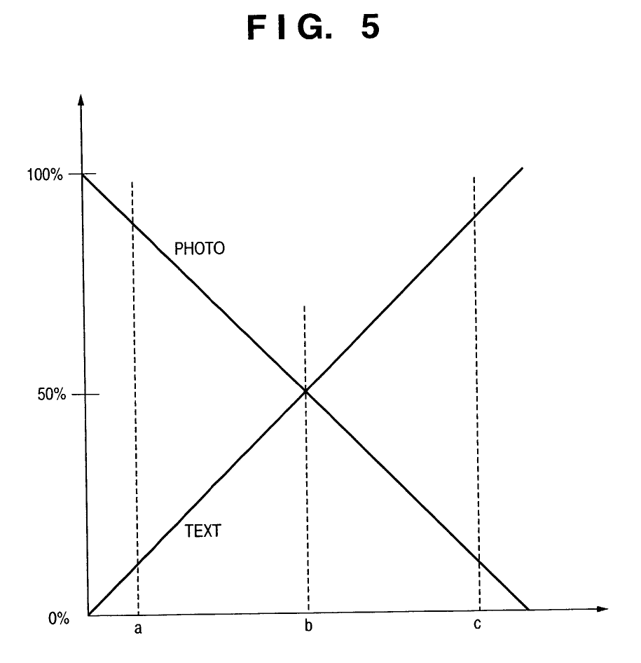

FIG. 5 shows the ratios of a text region and non-text region (photo region in this example). In FIG. 5, a, b, and c indicate the ratios of text and photo regions of given input images. For example, an input image at point a has image ratios of 10% (text region) and 90% (photo region). That is, FIG. 5 shows that the photo region has a larger ratio in the entire image on the left side; and to the right the ratio of the photo region decreases while the ratio of the text region increases. These ratios a, b, and c are output from the encoding attribute discrimination unit 120 and are input to the encoding quantization matrix selector 121. Note that the encoding quantization matrix selector 121 can also be expressed as a function f(x) which returns a code that designates a quantization matrix upon receiving a ratio (x). A function that directly outputs a quantization matrix in place of the code may be used. In these cases, a quantization matrix may be calculated by substituting the ratio x. Alternatively, a plurality of quantization matrices may be stored in a memory (not shown) or the like, and an appropriate quantization matrix corresponding to the ratio x may be read out and passed to the image data encoder 103. Note that the function may be either a mathematical function or that in a program language.

Since deterioration of image quality due to compression is inconspicuous in a photo region compared to a text region, coarser quantization steps can be set for the photo region. Hence, a high compression ratio can be assured, and the storage size of the compressed image can be greatly reduced compared to that of an original image. For the sake of simplicity, a quantization matrix for the photo region will be fixedly examined. T1 indicates an example of this photo quantization matrix as that for 8×8 DCT coefficients:

$$T1 = ( \begin{matrix}16 & 11 & 10 & 16 & 24 & 40 & 51 & 61 \\ 12 & 12 & 14 & 19 & 26 & 58 & 60 & 55 \\ 14 & 13 & 16 & 24 & 49 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} )$$

In case of the image at point a in FIG. 5, the photo region has a larger ratio. In such image, finer quantization steps can be set for the text region. Since the text region is relatively small, even when the compression ratio of the text region is low, the compression ratio of the photo region contributes to an increase in compression ratio of the entire image. Hence, a quantization matrix for the text region of image a is described by:

$$T2 = ( \begin{matrix}02 & 02 & 02 & 02 & 03 & 05 & 06 & 07 \\ 02 & 02 & 02 & 02 & 03 & 06 & 07 & 06 \\ 02 & 02 & 02 & 03 & 05 & 06 & 07 & 06 \\ 02 & 02 & 03 & 03 & 06 & 09 & 09 & 07 \\ 02 & 03 & 04 & 06 & 07 & 11 & 11 & 08 \\ 03 & 04 & 06 & 07 & 09 & 11 & 12 & 10 \\ 05 & 07 & 08 & 09 & 11 & 13 & 13 & 11 \\ 08 & 10 & 10 & 10 & 12 & 12 & 11 & 10\end{matrix} )$$

In general, an upper left value in a matrix represents a quantization step for a DC component of DCT coefficients, and values represent quantization steps for higher-frequency components to the right or lower side. As a smaller numerical value is set, the quantization step is smaller, i.e., information of an original image is preserved more accurately. In matrix T2, smaller numerical values are set to the right or lower side compared to T1. That is, compared to a photo quantization matrix, a text quantization matrix can eliminate deterioration of a text image due to compression since information of high-frequency components is preserved, although the compression ratio becomes high.

Point b in FIG. 5 indicates an image which includes text and photo regions at the same ratios. Since the area of the photo region in the entire image becomes smaller than the image with ratios a, contribution of the photo region to image compression becomes small. For this reason, a quantization matrix for the text region of the image with ratios b is described by:

$$T3 = ( \begin{matrix}07 & 05 & 05 & 07 & 10 & 17 & 21 & 25 \\ 05 & 05 & 06 & 08 & 11 & 24 & 25 & 23 \\ 06 & 06 & 07 & 10 & 17 & 23 & 28 & 23 \\ 06 & 07 & 09 & 12 & 21 & 35 & 33 & 25 \\ 08 & 09 & 15 & 23 & 28 & 44 & 42 & 31 \\ 10 & 15 & 23 & 26 & 33 & 42 & 46 & 37 \\ 20 & 26 & 32 & 35 & 42 & 49 & 49 & 41 \\ 29 & 37 & 39 & 40 & 45 & 45 & 42 & 40\end{matrix} )$$

Since information of high-frequency components is slightly dropped compared to T2, this quantization matrix can assure a high compression ratio.

Likewise, when an image has ratios c in FIG. 5, the ratio of the text region is high. The relationship between the text and photo regions at point c is opposite to that at point a. In this case, since the area of the photo region in the entire image is very small, contribution of the photo region to the compression ratio cannot be expected. For this reason, a quantization matrix for the text region of an image with ratios c in FIG. 5 is described by:

$$T4 = ( \begin{matrix}13 & 09 & 09 & 13 & 20 & 33 & 41 & 49 \\ 10 & 10 & 12 & 16 & 21 & 47 & 49 & 45 \\ 12 & 11 & 13 & 20 & 33 & 46 & 56 & 45 \\ 12 & 14 & 18 & 24 & 41 & 70 & 65 & 50 \\ 15 & 18 & 30 & 45 & 55 & 88 & 83 & 62 \\ 20 & 29 & 45 & 52 & 65 & 84 & 91 & 74 \\ 40 & 52 & 63 & 70 & 83 & 97 & 97 & 81 \\ 58 & 74 & 77 & 79 & 90 & 89 & 83 & 80\end{matrix} )$$

Since information of high-frequency components is further slightly dropped compared to T3, this quantization matrix can assure a high compression ratio. In this way, the entire image can have a desired compression ratio.

Note that quantization matrices T1, T2, T3, and T4 are merely examples. In matrices T3 and T4, high-frequency components are dropped to increase the compression ratio. However, these matrices can be arbitrarily changed in consideration of the balance between high- and low-frequency components.

In this embodiment, four quantization matrices T1, T2, T3, and T4 are described, but five or more quantization matrices may be prepared. Also, the quantization matrix for the photo region has been fixedly explained. However, the photo quantization matrix can also be selected in accordance with the ratios of the text and photo regions.

Upon decoding compressed data, the compressed attribute flag data is decoded, and the number of pixels with text attributes in a tile is counted to check if that tile corresponds to a text region. The ratios are calculated, and dequantization matrices corresponding to T1 and one of T2, T3, and T4 are set based on the checking result and calculation result to decode the data.

In the above description, quantization matrices T1, T2, T3, and T4, and corresponding dequantization matrices are pre-stored in the quantizer 203 and dequantizer 207 shown in FIGS. 2A and 2B, are selectively used in accordance with the attribute of image data and the ratio of that attribute in the image, and are switched for respective tiles.

[Second Embodiment]

In the first embodiment, the quantization and dequantization matrices to be set are switched with reference to attribute flag data for respective pixels. More specifically, in the first embodiment, upon decoding compressed image data, attribute flag data for respective pixels must be decoded, and the decoded flag data must be statistically processed for one tile. In other words, both the encoding and decoding sides must comprise a count block for the statistical process.

Hence, in the second embodiment, code information tn which indicates one of quantization matrices T1, T2, T3, and T4, which is used by the quantizer, is stored in the header field of compressed image data for each tile.

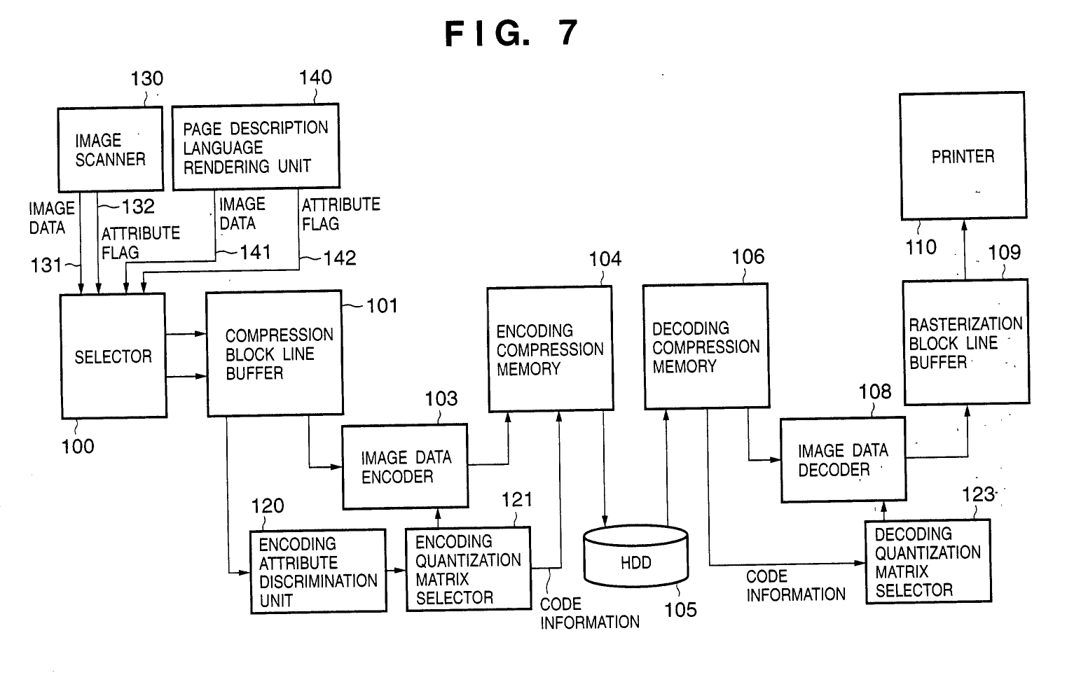

FIG. 7 shows the arrangement of an image processing apparatus of this embodiment. The same processes as those in the first embodiment are executed until the quantization matrix is selected. When the encoding quantization matrix selector 121 selects a quantization matrix Tn (n=1, 2, 3, . . . ), it outputs code information tn (n=1, 2, 3, . . . ) of the selected quantization matrix Tn to the encoding compression memory 104. This code information Tn is identification information of the quantization matrix Tn.

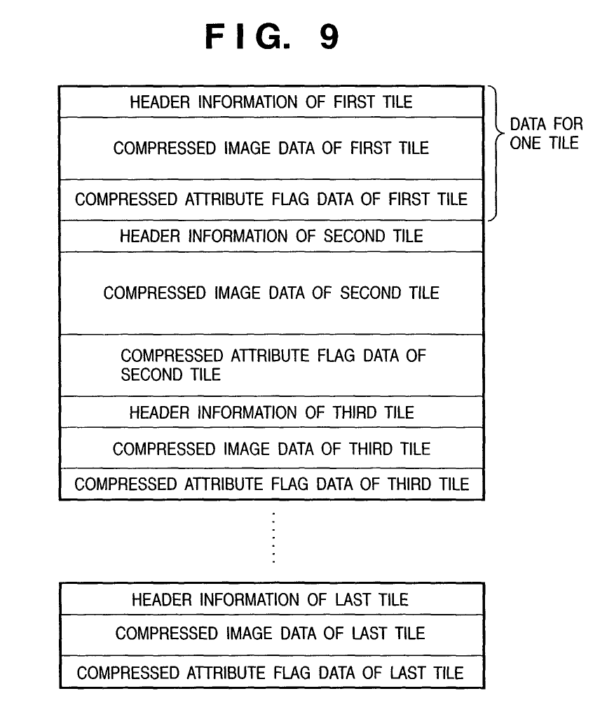

FIG. 9 shows the data structure when the compressed image data and attribute flag data are stored in an image storage unit (104 to 106). Header information of the first tile, compressed image data of the first tile, compressed attribute flag data of the first tile, . . . are written in turn from the head of data, and information is written until the last tile contained in one page. Note that the runlength-encoded attribute flag data is allocated at the footer position, but may be allocated at the header position. The header information of each tile records the data size of compressed data, tile number, and the like, and also code information tn which indicates T1, or T2, T3, or T4 used as the quantization matrix of image data. In the second embodiment, attribute flag data in FIG. 9 can be omitted.

Upon decoding recorded encoded data, information indicating one of T1, T2, T3, and T4 is read with reference to the header information to select a corresponding dequantization matrix used in dequantization.

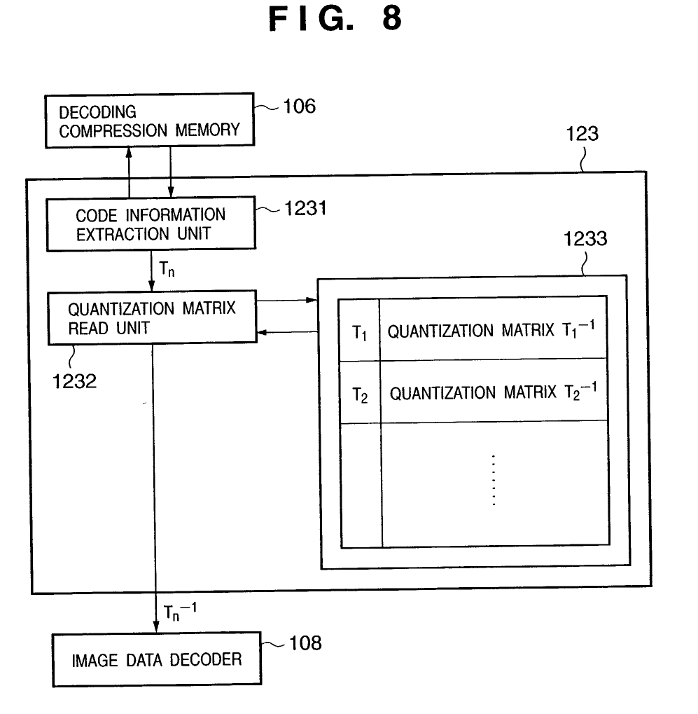

FIG. 8 shows an example of the arrangement of the decoding quantization matrix selector 123 on the decoding side. When the decoding process is launched on the decoding side, a code information extraction unit 1231 reads out code information tn from the header stored in the decoding compression memory 106, and outputs it to a quantization matrix read unit 1232. The quantization matrix read unit 1232 reads out a dequantization matrix Tn⁻¹ corresponding to the code information tn from a storage device 1233, and outputs it to the image data decoder 108.

Information other than the code of the quantization matrix may be used. For example, the number or ratio of natural image pixels contained in one tile, the number or ratio of non-natural image pixels contained in one tile, or the ratio of natural and non-natural image pixels contained in one tile may be used. Also, attribute information for each region may be used.

In this embodiment, the encoded tile data and header are alternately allocated, but another data structure may be used. For example, the headers of all the tiles may be allocated together. Or two corresponding headers may be allocated together before two compressed tile data. That is, the data structure is not particularly limited as long as an encoding method used to encode each tile can be estimated.

In this embodiment, upon decoding compressed image data, since the dequantization matrix can be switched with reference to only the header field, attribute flag data for respective pixels need not be referred to upon decoding.

For this reason, the attribute flag data encoder 102 can be omitted on the encoding side. On the other hand, the attribute flag data decoder 107 and decoding attribute discrimination unit 122 of attribute flag data can be omitted on the decoding side. For this reason, the present invention can be practiced using an arrangement simpler than the first embodiment.

[Third Embodiment]

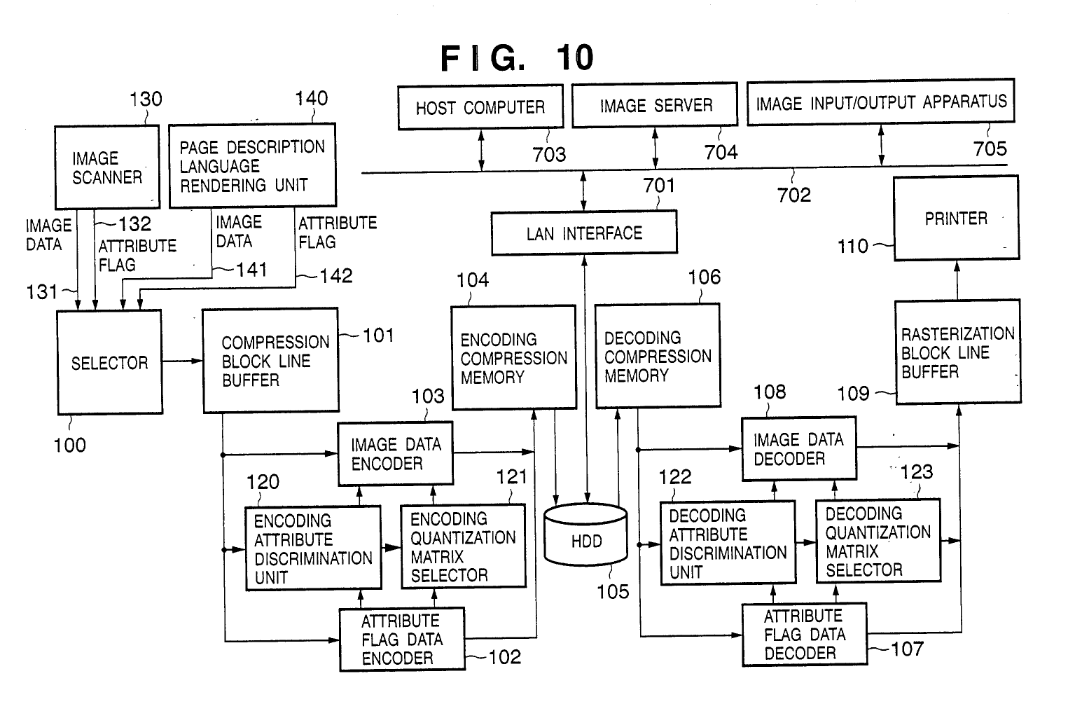

In the third embodiment, an arrangement when the image processing apparatus according to the first embodiment of the present invention shown in FIG. 1 is connected to a predetermined network will be explained using FIG. 10.

Referring to FIG. 10, reference numeral 701 denotes a LAN interface, which is an interface that can connect a network 702.

Compressed image data stored in the external storage device (HDD) 105 that stores compressed images can be sent to a host computer 703, image server 704, image input/output apparatus 705, and the like, which are connected to the network 702, via the LAN interface 701 and network.

Also, compressed image data can be received from the host computer 703, image server 704, image input/output apparatus 705, and the like, which are connected to the network 702, via the network, and can be stored in the external storage device 105.

The LAN interface may be connected to the compression block line buffer 101, rasterization block line buffer 109, encoding compression memory 104, decoding compression memory 106, or the like other than the external storage device (HDD) 105. However, since it is efficient to send/receive compressed images in consideration of the load on the network, the LAN interface is preferably connected to the external storage device (HDD) 105.

Although not shown, a JPEG encoder and decoder for implementing encoding and decoding that do not require any attribute flag data may be added, and may be used upon exchanging data with an apparatus which does not use attribute flag data.

Furthermore, the image processing apparatus may be connected to an image transmission/reception apparatus such as a facsimile or the like that uses a telephone line, so as to transfer an image, or may be connected to another image input/output apparatus, image server, host computer, and the like via a wireless network or the like so as to send/receive an image.

[Fourth Embodiment]

In the first to third embodiments, an image processing apparatus which can efficiently compress a mixed image which includes both natural and non-natural images, and can improve the quality of the compressed image compared to the conventional method has been explained. In this embodiment, an image processing apparatus which can improve the compression efficiency of a non-natural image while maintaining a high image quality level will be explained below.

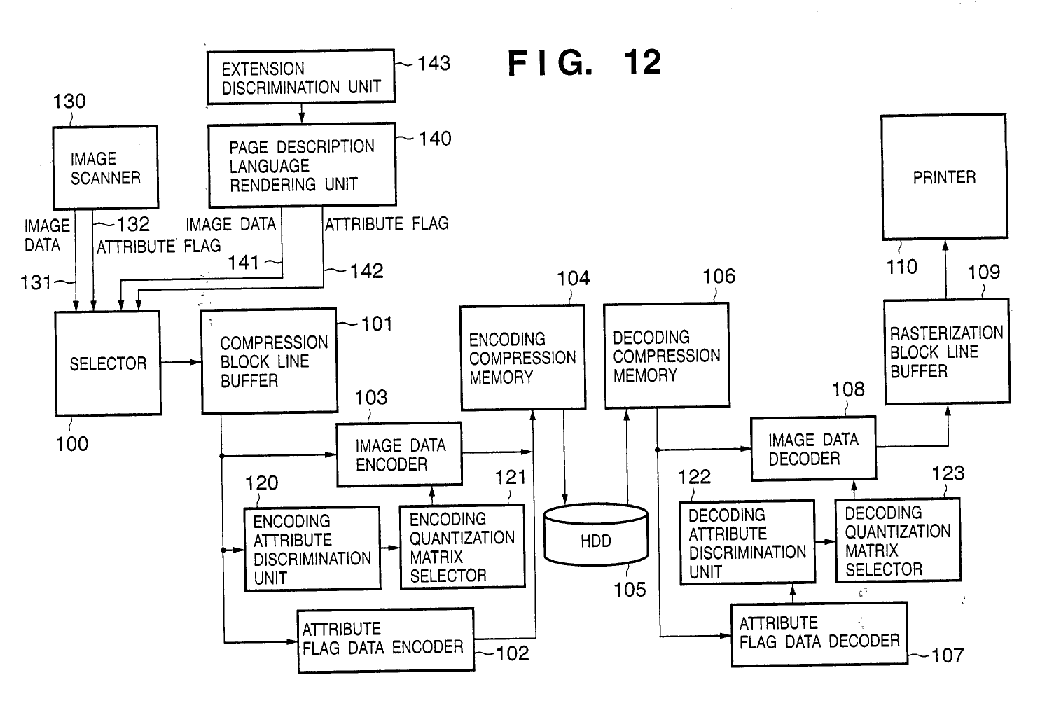

FIG. 12 is a block diagram showing details of the signal processing unit 811 having image input, storage, and output means according to the fourth embodiment of the present invention.

The signal processing unit 811 of this embodiment discriminates the attribute of an image, and also the type of image (image format), and executes a selection process of a quantization matrix used in compression of an image using the discrimination result (extension discrimination information) of the type of image, and the discrimination result (attribute discrimination information) of attributes. Since an optimal quantization matrix is selected in accordance with the type of image (image format) and attribute, the processing speed of the image compression process can be improved, a storage unit that saves compressed images can be effectively used, and deterioration of the image quality due to compression can be minimized.

The signal processing unit 811 according to this embodiment will be described in detail below.

FIG. 12 is a functional block diagram of the signal processing unit 811 according to the fourth embodiment of the present invention. Reference numeral 130 denotes an image scanner, which receives an image signal read by the image reader section 801. The image signal received by the image scanner 130 is image data, the image format of which is bitmap or the like.

On the other hand, reference numeral 140 denotes a page description language (PDL) rendering unit which is used to receive an image (PDL data) described in PDL from an external computer (not shown) via an extension discrimination unit 143. Whether the image scanner 130 or the PDL rendering unit 140 is used can be switched by a selector 100.

Image data input to the image scanner 130 undergoes an image region separation process, thus generating attribute flag data for respective pixels. As a result, the image scanner 130 outputs image data 131 and attribute flag data 132, which are temporarily stored in a compression block line buffer 101 via the selector 100. Note that the image region separation process of image data is the state-of-the-art technique, and a detailed description thereof will be omitted.

On the other hand, upon receiving PDL data via the extension discrimination unit 143, the PDL rendering unit 140 interprets PDL commands to generate image data 141. At this time, the unit 140 generates attribute flag data 142 on the basis of information indicating the type of command, and the attribute flag data 142 is temporarily stored in the compression block line buffer 101 together with the image data 141.

Note that the extension discrimination unit 143 discriminates an extension that indicates the type of image (image format) on the basis of PDL data before being input to the PDL rendering unit 140.

Reference numerals 102 and 103 respectively denote an attribute flag data encoder and image data encoder, which encode attribute flag data or image data stored in the compression block line buffer 101. Reference numeral 120 denotes an encoding attribute discrimination unit, which discriminates the attribute of input image data using the attribute flag data stored in the compression block line buffer 101, and outputs attribute discrimination information.

Upon discriminating the attribute of image data, the number of pixels, which are determined based on attribute flag data to have a non-natural image attribute, is counted, and when the count value is equal to or larger than a predetermined value, a non-natural image attribute is determined.

Reference numeral 121 denotes an encoding quantization matrix selector, which selects an optimal quantization matrix on the basis of the attribute discrimination result (attribute discrimination information) of image data discriminated by the encoding attribute discrimination unit 120, and the extension (extension discrimination information) of the image discriminated by the aforementioned extension discrimination unit 143, and outputs the selected quantization matrix to the image data encoder 103. The image data encoder 103 encodes image data using the quantization matrix selected by the encoding quantization matrix selector 121.

Reference numeral 104 denotes an encoding compression memory, which temporarily stores encoded data (encoded image data and encoded attribute flag data) obtained by the attribute flag data encoder 102 and image data encoder 103. Upon storing the encoded data, the extension discrimination information output from the extension discrimination unit 143 is stored together as a part of the encoded data. Reference numeral 105 denotes a hard disk (HDD), which saves the encoded data temporarily stored in the encoding compression memory 104.

Reference numeral 106 denotes a decoding compression memory, which temporarily stores the encoded data (including encoded image data, corresponding encoded attribute flag data, and extension discrimination information) in the hard disk (HDD) 105 upon printing out the encoded image data in the hard disk (HDD) 105 via a printer 110. Reference numerals 107 and 108 respectively denote an attribute flag data decoder and image data decoder, which decode the encoded attribute flag data and encoded image data stored in the decoding compression memory 106. Reference numeral 122 denotes a decoding attribute discrimination unit, which discriminates the attribute of an image to be processed using the attribute flag data decoded by the attribute flag data decoder 107. Note that the attribute discrimination process of image data is the same as that in the aforementioned encoding attribute discrimination unit 120.

Reference numeral 123 denotes a decoding quantization matrix selector, which selects an optimal dequantization matrix on the basis of the attribute discrimination result discriminated by the decoding attribute discrimination unit 122, and the extension discrimination information stored as a part of the encoded data, and outputs the selected dequantization matrix to the image data decoder 108. The image data decoder 108 decodes the encoded image data using the dequantization matrix selected by the decoding quantization matrix selector 123.

Reference numeral 109 denotes a rasterization block line buffer which temporarily stores image data obtained by the image data decoder 108, and then outputs it to the printer 110.

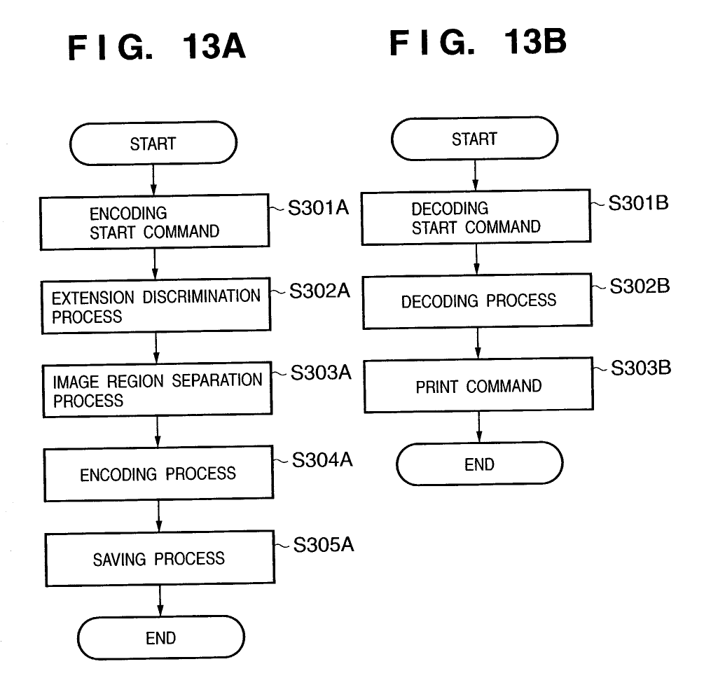

FIG. 13A is a flow chart when a processing controller (not shown) that controls the processes in the aforementioned signal processing unit 811 controls to execute the encoding process of the signal processing unit 811. FIG. 13A shows an example when an image is input via the PDL rendering unit 140.

Upon receiving an encoding start command in step S301A, the controller instructs the extension discrimination unit 143 to execute an extension discrimination process (step S302A).

The extension discrimination unit 143 sends an input image (PDL data) to the PDL rendering unit 140, and discriminates an extension based on the PDL data. Information associated with the discriminated extension (extension discrimination information) is input to the encoding quantization matrix selector 121. Note that the extension discrimination method can be implemented using the state-of-the-art technique, and a detailed description thereof will be omitted.

After completion of the extension discrimination process, the controller instructs the PDL rendering unit 140 to execute an image region separation process (step S303A). The PDL rendering unit 140 interprets PDL commands of the image (PDL data) described in PDL to generate and output image data 141. Also, the unit 140 generates attribute flag data 142 for respective pixels, which are used to identify pixels which form a text part, with reference to information indicating the types of PDL commands, and outputs them to the compression block line buffer 101 via the selector 100.

Note that the attribute flag data is not limited to one which is used to identify a pixel that forms a text part. For example, multi-bit information indicating various attributes such as a photo part, print part, color text part, thin line part, halftone dot part, vector graphics part, and the like may be used as the attribute flag data.

In step S304A, the controller instructs the image data encoder 103 and attribute flag data encoder 102 to execute an encoding process. The attribute flag data encoder 102 reads out and encodes the attribute flag data stored in the compression block line buffer 101 on the basis of a predetermined quantization matrix, and temporarily stores encoded attribute flag data in the encoding compression memory 104. On the other hand, the image data encoder 103 reads out and encodes image data stored in the compression block line buffer 101 using a quantization matrix selected by the encoding quantization matrix selector 121. Encoded image data is temporarily stored in the encoding compression memory 104.

In step S305A, the controller instructs the encoding compression memory 104 to save the encoded data in the hard disk 105. In this manner, the encoded data (including the encoded image data, encoded attribute flag data, and extension discrimination information) stored in the encoding compression memory 104 is stored in the hard disk 105, thus ending the processing.

FIG. 13B is a flow chart when the processing controller (not shown) that controls the processes in the aforementioned signal processing unit 811 controls to execute the decoding process of the signal processing unit 811.

Upon receiving a decoding start command in step S301B, the controller instructs the hard disk 105 to output predetermined encoded data. The hard disk 105 outputs predetermined one of the stored encoded data. Note that the output encoded data is temporarily stored in the decoding compression memory 106.

In step S302B, the controller instructs the attribute flag data decoder 107 and image data decoder 108 to execute a decoding process. The attribute flag data decoder 107 reads out and decodes encoded attribute flag data from the decoding compression memory 106 in response to the decoding process instruction. The decoded attribute flag data are supplied to the decoding attribute discrimination unit 122 to discriminate the attribute of an image. The decoding quantization matrix selector 123 selects a dequantization matrix on the basis of the attribute of the image discriminated by the decoding attribute discrimination unit 122, and extension discrimination information stored as a part of the encoded data, and sends it to the image data decoder 108. The image data decoder 108 decodes encoded image data read out from the decoding compression memory 106 on the basis of the selected dequantization matrix, and the decoded image data is temporarily stored in the rasterization block line buffer 109.

Upon completion of the decoding process, the controller issues a print instruction to the printer 110 in step S303B. Upon receiving the print instruction from the processing controller (not shown), the printer 110 receives image data stored in the rasterization block line buffer 109, and prints it out.

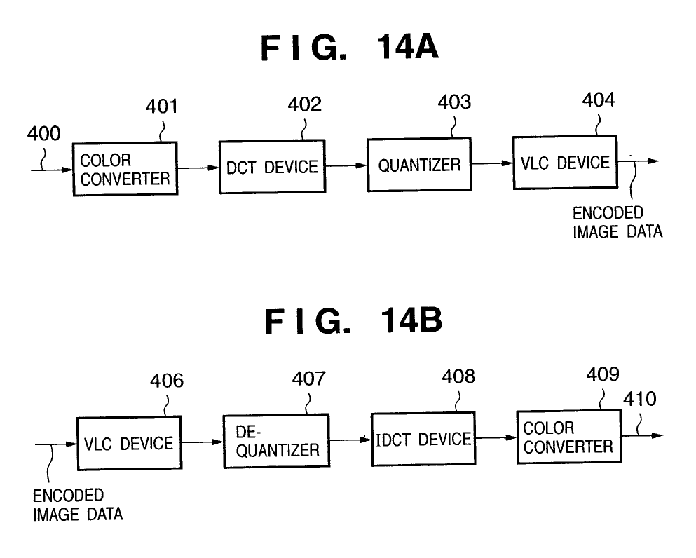

FIGS. 14A and 14B show the internal arrangements of the image data encoder 103 and image data decoder 108 shown in FIG. 12.

The image data encoder 103 includes a color converter 401, discrete cosine transformation (DCT) device 402, quantizer 403, and variable-length encoding (VLC) device 404. The image data decoder 108 includes a variable-length decoding (VLD) device 406, dequantizer 407, inverse DCT (IDCT) device 408, and color converter 409.

Image data 400 input from the compression block line buffer 101 is, for example, a color image signal, and has three-color, i.e., red (R), green (G), and blue (B) 256-level signals. The color converter 401 converts R, G, and B signals into luminance and color difference signals (Y, Cb, and Cr signals).

The DCT (discrete cosine transformation) device 402 computes the spatial frequency transforms (DCTs) of each of the luminance and color difference signals obtained by the color converter 401 for 8×8 pixels.

The quantizer 403 quantizes DCT coefficients obtained by the DCT device 402 using the quantization matrix selected by the encoding quantization matrix selector 121, thus reducing the data size of image data.

The variable-length encoding (VLC) device 404 executes a Huffman encoding process of the quantized values obtained by the quantizer 403 to further reduce the data size of the image data, thus obtaining encoded image data.

On the other hand, encoded image data (including encoded image data, encoded attribute flag data, and extension discrimination information) stored in the hard disk 105 is input to the VLD device 406 via the decoding compression memory 106, and undergoes Huffman decoding.

The dequantizer 407 restores data that has undergone the process in the variable-length decoding (VLD) device 406 to DCT coefficient values using the dequantization matrix selected by the decoding quantization matrix selector 123.

The IDCT (inverse DCT) device 408 computes the inverse DCTs of the DCT coefficient values obtained by the dequantizer 407 to acquire luminance and color difference signals.

The color converter 409 restores the luminance and color difference signals obtained by the IDCT device 408 to R, G, and B image signals. As a result, R, G, and B image signals 410 (color image signal) obtained by the color converter 409 of the image data decoder 108 are, e.g., printed out via the printer 110.

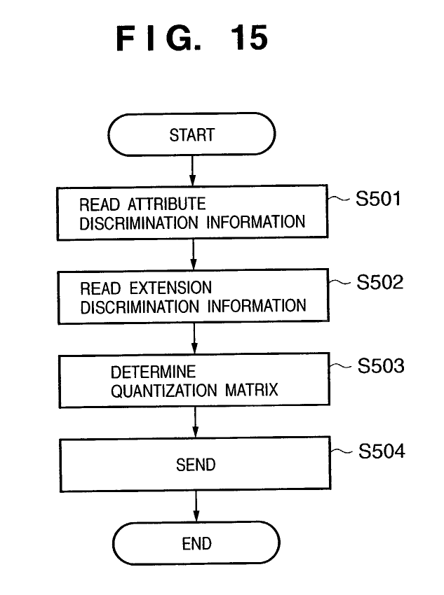

The selection process of the quantization or dequantization matrix in the encoding quantization matrix selector 121 or decoding quantization matrix selector 123 will be described below using FIGS. 15 to 18B.

FIG. 15 is a flow chart showing the flow of the selection process of the encoding quantization matrix selector 121. The attribute discrimination result (attribute discrimination information) of image data discriminated by the encoding attribute discrimination unit 120 is read in step S501, and the extension discrimination information discriminated by the extension discrimination unit 143 is read in step S502.

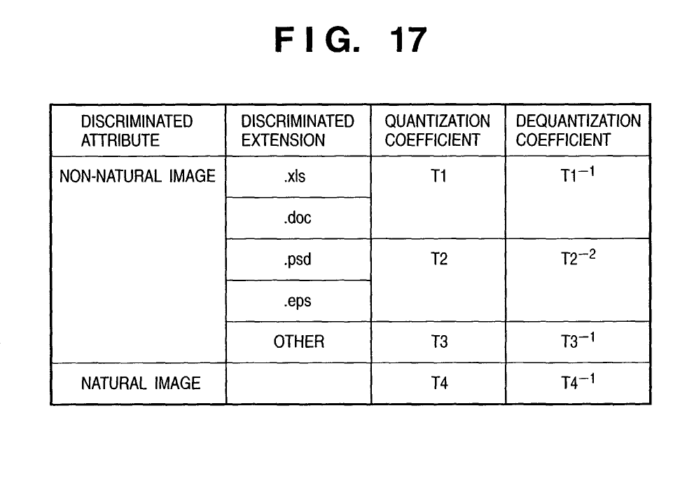

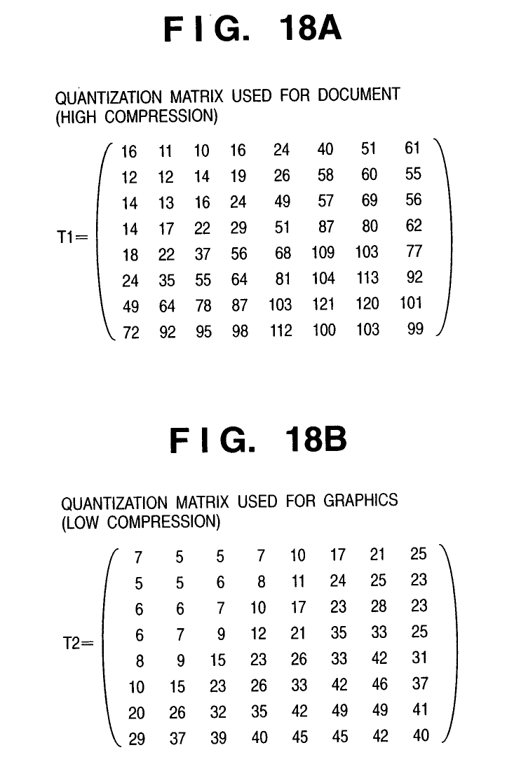

In step S503, a quantization matrix is selected on the basis of the attribute discrimination information and extension discrimination information read in steps S501 and S502. As a practical selection method of a quantization matrix, for example, a plurality of quantization matrices for a non-natural image are prepared, as shown in FIG. 17. When a file that handles a document or the like (*.doc, *.xls, or the like) is input, a quantization matrix T1 is selected. When a file that handles graphics or the like (*psd, *.eps, or the like) is input, a quantization matrix T2 is selected. When a file other than the aforementioned files is input, a quantization matrix T3 is selected. In this manner, when the contents of the attribute discrimination information are “non-natural image” and the discriminated extension is “.xls”, “T1” can be selected as a quantization matrix. Note that predetermined values are set in each quantization matrix, and FIGS. 18A and 18B show examples of T1 and T2 (examples of quantization matrices for DCT coefficients for 8×8 pixels; T1 is a matrix for high compression, and T2 is a matrix for low compression).

In the above example, three different quantization matrices are used for a non-natural image. However, an arbitrary number of quantization matrices may be used. Furthermore, the types of files are not limited to those described above, and arbitrary types of files may be used.

The quantization matrix selected in step S503 is sent to the image data encoder 103 in step S504.

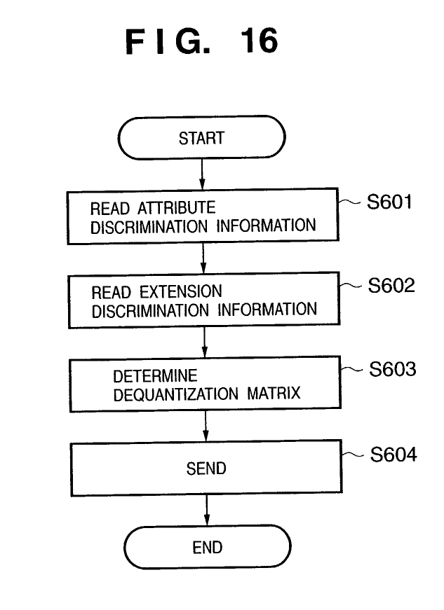

FIG. 16 is a flow chart showing the flow of the selection process of the decoding quantization matrix selector 123. The attribute discrimination result (attribute discrimination information) of image data discriminated by the decoding attribute discrimination unit 122 is read in step S601, and the extension discrimination information contained in encoded data is read in step S602.

In step S603, a dequantization matrix is selected on the basis of the attribute discrimination information and extension discrimination information read in steps S601 and S602. As a practical selection method of a dequantization matrix, as in selection of the quantization matrix, for example, a plurality of quantization matrices for a non-natural image are prepared, as shown in FIG. 17. When a file that handles a document or the like (*.doc, *.xls, or the like) is input, a dequantization matrix T1⁻¹ is selected. When a file that handles graphics or the like (*psd, *.eps, or the like) is input, a dequantization matrix T2⁻¹ is selected. When a file other than the aforementioned files is input, a dequantization matrix T3⁻¹ is selected. In this manner, when the contents of the attribute discrimination information are “non-natural image” and the discriminated extension is “.xls”, “T1⁻¹” can be selected as a dequantization matrix. Note that predetermined values are set in each dequantization matrix.

The dequantization matrix selected in step S603 is sent to the image data decoder 108 in step S604.

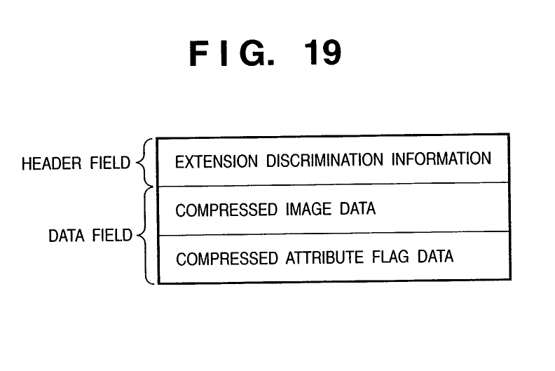

FIG. 19 shows the data structure when the compressed image data and attribute flag data (i.e., encoded image data and encoded attribute flag data) are stored in the encoding compression memory 104. Extension discrimination information is stored in a header field at the head of data, and the compressed image data (encoded image data) and compressed attribute flag data (encoded attribute flag data) are then stored. In this embodiment, the extension discrimination information is stored in the header field of encoded data. However, the present invention is not limited to such specific format, and the extension discrimination information may be stored as an independent file corresponding to encoded data.

As described above, according to this embodiment, since the quantization matrix is automatically switched in accordance with the type of image (image format), compression suitable for the image format (low compression for graphic or the like) can be done, and a reduction of deterioration of the image quality and efficient use of the hard disk can be realized.

[Fifth Embodiment]

In the fourth embodiment, extension and attribute discrimination processes are done for each input image to switch a quantization matrix. Alternatively, an image may be segmented into a plurality of regions, and a quantization matrix may be switched for each region.

In this embodiment, a case will be explained below wherein the signal processing unit 811 in FIG. 11 executes a switching process of a quantization matrix within M×N pixels, and encodes within M×N pixels.

More specifically, for example, the compression block line buffer 101 segments input image data into tiles (blocks) each consisting of M×N pixels, and outputs the tile data.

The image data encoder 103 and attribute flag data encoder 102 executes discrete cosine transformation encoding (JPEG encoding) of image data and runlength encoding of attribute flag data for each block of M×N pixels.

Note that “M” and “N” of the block size are integer multiples of a window size (block size) in discrete cosine transformation encoding. For example, assume that the window size in JPEG encoding is 8×8 pixels, and “M”=“N”=32. In this case, in JPEG encoding, a block consisting of 32×32 pixels is further broken up into 16 blocks each having 8×8 pixels, and encoding is done for each block having 8×8 pixels.

Therefore, the image data encoder 103 executes a so-called DCT process for 16 windows each consisting of 8×8 pixels contained in a block image consisting of 32×32 pixels from the compression block line buffer 101 to quantize input image. A quantization matrix used in this case can be switched for each block consisting of M×N pixels, and this switching is done by outputting attribute discrimination information, which is discriminated by the encoding attribute discrimination unit 120 with reference to attribute flag data of 32×32 pixels corresponding to the image data, to the encoding quantization matrix selector 121.

Attribute flag data is assigned to each pixel. However, since an encoding method in each tile of M×N pixels is constant in the present invention, attribute flag data in a tile must be analyzed by the attribute flag encoder 102 to determine an attribute that represents the tile.

In this case, whether or not a tile contains a character is discriminated. If a tile of 32×32 pixels contains at least one pixel with a text attribute flag, it can be determined that the tile contains a character. Or the number of pixels with text attribute flag data is counted within a tile, and only when the count value exceeds a predetermined threshold value, it can be determined that the tile contains a character.

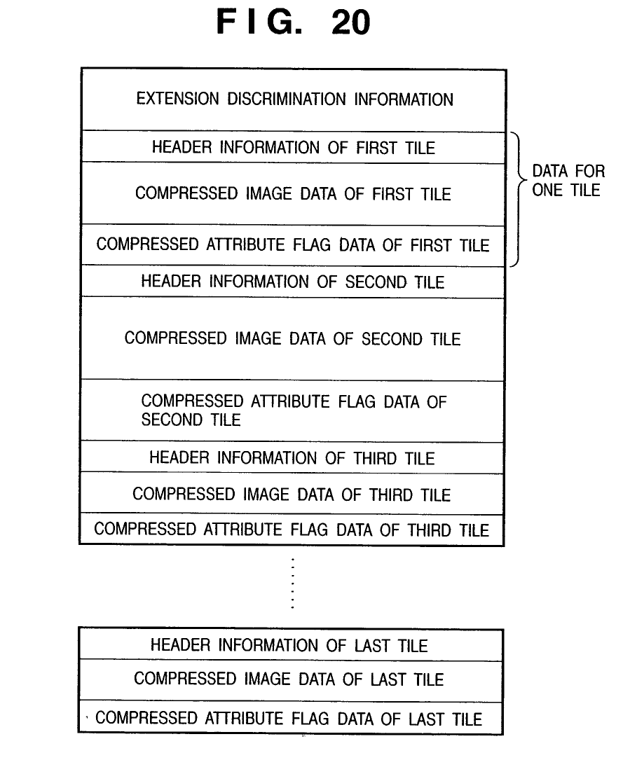

The image data and attribute flag data which are compressed for respective tiles are stored in the encoding compression memory 104 with the data structure (example) shown in FIG. 20. That is, extension discrimination information, header information of the first tile, compressed image data of the first tile, compressed attribute flag data of the first tile, . . . are stored in turn from the head of data. Upon decoding, an attribute is discriminated for each tile to select a dequantization matrix.

[Another Embodiment]

The objects of the present invention are also achieved by supplying a storage medium, which records a program code of software that can implement the functions of a host and terminal of the above-mentioned embodiments to a system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a ROM, floppy disk, hard disk, optical disk, magneto-optical disk, CD-ROM, CD-R, magnetic tape, nonvolatile memory card, and the like may be used.

The functions of the above-mentioned embodiments may be implemented not only by executing the readout program code by the computer but also by some or all of actual processing operations executed by an OS running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

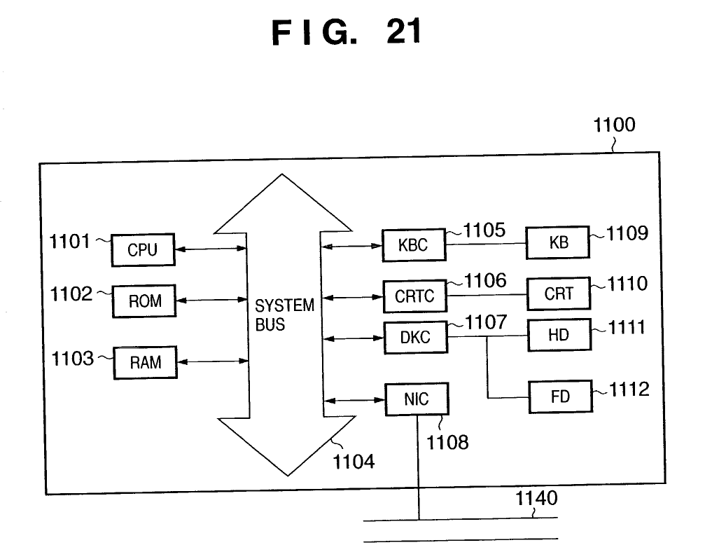

FIG. 21 shows the functions of the computer. For example, the image processing apparatus 800 comprises a computer function 1100 shown in FIG. 21, and the operation of each of the above embodiments is implemented by its CPU 1101.

As shown in FIG. 21, the computer function 1100 comprises a CPU 1101, a ROM 1102, a RAM 1103, a keyboard controller (KBC) 1105 for a keyboard (KB) 1109, a CRT controller (CRTC) 1106 for a CRT display (CRT) 1110 serving as a display unit, a disk controller (DKC) 1107 for a hard disk (HD) 1111 and floppy disk (FD) 1112, and a network interface card (NIC) 1108, which are connected via a system bus 1104 to allow intercommunications.

The CPU 1101 systematically controls the respective building components connected to the system bus 1104 by executing software stored in the ROM 1102 or HD 1111 or that supplied from the FD 1112.

That is, the CPU 1101 reads out a processing program according to a processing sequence described in each of the above embodiments from the ROM 1102, HD 1111, or FD 1112, and executes it, thereby making control for implementing the operation in each of the above embodiments.

The RAM 1103 serves as a main memory or work area of the CPU 1101.

The KBC 1105 controls instruction inputs from the KB 1109, a pointing device (not shown), and the like.

The CRTC 1106 controls display on the CRT 1110.

The DKC 1107 controls access to the HD 1111 and FD 1112, which store a boot program, various applications, edit files, user files, network management program, the processing programs in the fourth and fifth embodiments, and the like.

The NIC 1108 controls two-way data exchange with another apparatus or system on a network 1140.

[Still Another Embodiment]

In each of the above embodiments, an all-in-one image processing apparatus shown in FIG. 11 has been explained. However, the present invention may be applied to either a system constituted by a plurality of devices (e.g., a host computer, interface device, reader, printer, and the like), or an apparatus consisting of a single equipment (e.g., a copying machine, facsimile apparatus, or the like).

[Yet Another Embodiment]

The encoding and decoding methods of the present invention can be distributed as encode and decode software programs. Hence, the objects of the present invention are also achieved by supplying a storage medium (or recording medium), which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. The functions of the above-mentioned embodiments may be implemented not only by executing the readout program code by the computer but also by some or all of actual processing operations executed by an operating system (OS) running on the computer on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the computer, after the program code read out from the storage medium is written in a memory of the extension card or unit.

When the present invention is applied to the storage medium, that storage medium stores a program code corresponding to the aforementioned flow chart shown in FIG. 6.

As many apparently widely different embodiments of the present invention can be made without departing from the spirit and scope thereof, it is to be understood that the invention is not limited to the specific embodiments thereof except as defined in the appended claims.

What is claimed is:

1. An image encoding apparatus comprising:
input means for inputting image data;
discrimination means for discriminating if each of a plurality of regions, which form the image data input by said input means, is a region of a first type, a quality of which becomes not more than a predetermined quality if the region is compressed at a predetermined compression ratio, or is a region of a second type, a quality of which exceeds the predetermined quality if the region is compressed at the predetermined compression ratio;
selection means for selecting an encoding method used in compression of the region on the basis of the type of each region discriminated by said discrimination means;
first compression means for compressing the region by the encoding method selected by said selection means; and
second compression means for compressing information associated with the type of region.

2. The apparatus according to claim 1, wherein the region of the first type is a region of a non-natural image, and the region of the second type is a region of a natural image.

3. The apparatus according to claim 2, wherein the non-natural image is an artificial image represented by a character, thin line, print halftone dots, or computer graphics, and the natural image is a photo image.

4. The apparatus according to claim 2, wherein the region is an encoding unit upon encoding, which is formed by a plurality of pixels, and
said discrimination means discriminates if each of the plurality of pixels, which form the region, belongs to the first or second type, executes a statistical process for each region, and determines based on a statistical amount obtained by the statistical process if the region belongs to the first or second type.

5. The apparatus according to claim 4, wherein the information associated with the type of each region is attribute information for each region, which indicates if the region belongs to the first or second type.

6. The apparatus according to claim 4, wherein the information associated with the type of each region is attribute information for each pixel, which indicates if each of pixels that form the region belongs to the first or second type.

7. The apparatus according to claim 4, wherein the information associated with the type of each region is code information indicating the encoding method selected by said selection means.

8. The apparatus according to claim 4, wherein the statistical process calculates the number of pixels, which belong to the first type, of the plurality of pixels that form the region, and
said discrimination means determines that the region is a region of the first type when the number of pixels which belong to the first type exceeds a predetermined threshold value.

9. The apparatus according to claim 1, wherein the encoding method specifies encoding coefficients used upon compressing image data.

10. The apparatus according to claim 9, wherein the encoding coefficients correspond to a quantization matrix used upon compressing image data.

11. The apparatus according to claim 1, further comprising forming means for forming a data structure which includes at least first compressed data obtained by said first compression means, and second compressed data obtained by said second compression means.

12. The apparatus according to claim 11, wherein said forming means stores the second compressed data obtained by said second compression means in a header field of the first compressed data obtained by said first compression means.

13. The apparatus according to claim 2, wherein said input means comprises a PDL rendering unit for generating a print image by interpreting PDL commands described in a page description language, and
said discrimination means discriminates based on the PDL commands interpreted by said PDL rendering unit if the region is a non-natural image region.

14. The apparatus according to claim 13, wherein said discrimination means determines based on the type of PDL command that a region consisting of character pixels, vector pixels, or graphic pixels is the non-natural image region.

15. The apparatus according to claim 1, wherein said first compression means compresses the region using irreversible or reversible compression, and
said second compression means compresses the information associated with the type of region using reversible compression.

16. The apparatus according to claim 11, further comprising sending means for sending the data structure formed by said forming means.

17. The apparatus according to claim 16, wherein said sending means is an interface used to establish connection to a wireless or wired channel.

18. The apparatus according to claim 17, further comprising sending control means for controlling sending of the first compressed data in accordance with a communication partner of said sending means.

19. The apparatus according to claim 16, further comprising:
partner discrimination means for discriminating if a communication partner of said sending means is compatible to an encoding method of said image encoding apparatus; and
instruction means for, only when said partner discrimination means affirms a compatible state of the communication partner, instructing said first and second compression means to execute a compression process.

20. The apparatus according to claim 16, further comprising:
partner discrimination means for discriminating if a communication partner of said sending means is compatible to an encoding method of said image encoding apparatus; and
third compression means for, when said partner discrimination means negates a compatible state of the communication partner, compressing the image data by an encoding method with which the partner can decode the compressed image data.

21. An image decoding apparatus for decoding encoded data, which is obtained by encoding a plurality of regions that form image data as units, to obtain the image data, comprising:
storage means for storing the encoded data;
first decoding means for decoding the encoded data stored in said storage means to obtain information associated with a type of region to be decoded;
discrimination means for discriminating, based on the information associated with the type of region decoded by said first decoding means, if the region is a region of a first type, a quality of which becomes not more than a predetermined quality if the region is compressed at a predetermined compression ratio, or is a region of a second type, a quality of which exceeds the predetermined quality if the region is compressed at the predetermined compression ratio;
selection means for selecting a decoding method used to decode the region on the basis of the information associated with the type of each region discriminated by said discrimination means; and
second decoding means for decoding the region by the decoding method selected by said selection means.

22. The apparatus according to claim 21, wherein the region of the first type is a region associated with a non-natural image, and the region of the second type is a region of a natural image.

23. The apparatus according to claim 22, wherein the non-natural image is an artificial image represented by a character, thin line, print halftone dots, or computer graphics, and the natural image is a photo image.

24. The apparatus according to claim 22, wherein said discrimination means discriminates if each of a plurality of pixels, which form the region, belongs to the first or second type, executes a statistical process for each region, and determines based on a statistical amount obtained by the statistical process if the region belongs to the first or second type.

25. The apparatus according to claim 24, wherein the information associated with the type of each region is attribute information for each region, which indicates if the region belongs to the first or second type.

26. The apparatus according to claim 24, wherein the information associated with the type of each region is attribute information for each pixel, which indicates if each of pixels that form the region belongs to the first or second type.

27. The apparatus according to claim 21, wherein the information associated with the type of each region is code information indicating an encoding method of the region.

28. The apparatus according to claim 21, wherein the information associated with the type of region is information associated with a PDL command.

29. The apparatus according to claim 24, wherein the statistical process calculates the number of pixels, which belong to the first type, of the plurality of pixels that form the region, and
said discrimination means determines that the region is a region of the first type when the number of pixels which belong to the first type exceeds a predetermined threshold value.

30. The apparatus according to claim 21, wherein said selection means specifies encoding coefficients used upon compressing image data, and selects decoding coefficients corresponding to the encoding coefficients.

31. The apparatus according to claim 30, wherein the encoding coefficients correspond to a quantization matrix used upon compressing image data.

32. The apparatus according to claim 21, wherein the encoded data is a data structure which includes at least first compressed data obtained by compressing the region, and second compressed data obtained by compressing the information associated with the type of region.

33. The apparatus according to claim 32, wherein the encoded data comprises the second compressed data as a header of the first compressed data.

34. The apparatus according to claim 21, wherein said first decoding means decodes the information associated with the type of region using coding corresponding to irreversible or reversible compression, and
said second decoding means decodes the region using coding corresponding to reversible compression.

35. The apparatus according to claim 21, further comprising reception means for receiving the data structure.

36. The apparatus according to claim 35, wherein said reception means is an interface used to establish connection to a wireless or wired channel.

37. An image encoding method comprising:
the input step of inputting image data;
the discrimination step of discriminating if each of a plurality of regions, which form the image data input in the input step, is a region of a first type, a quality of which becomes not more than a predetermined quality if the region is compressed at a predetermined compression ratio, or is a region of a second type, a quality of which exceeds the predetermined quality if the region is compressed at the predetermined compression ratio;
the selection step of selecting an encoding method used in compression of the region on the basis of the type of each region discriminated in the discrimination step;
the first compression step of compressing the region by the encoding method selected in the selection step; and
the second compression step of compression information associated with the type of region.

38. The method according to claim 37, wherein the region of the first type is a region associated with a non-natural image, and the region of the second type is a region of a natural image.

39. The method according to claim 38, wherein the non-natural image is an artificial image represented by a character, thin line, print halftone dots, or computer graphics, and the natural image is a photo image.

40. The method according to claim 38, wherein the region is an encoding unit upon encoding, which is formed by a plurality of pixels, and
the discrimination step includes the step of discriminating if each of the plurality of pixels, which form the region, belongs to the first or second type, executing a statistical process for each region, and determining based on a statistical amount obtained by the statistical process if the region belongs to the first or second type.

41. The method according to claim 40, wherein the information associated with the type of each region is attribute information for each region, which indicates if the region belongs to the first or second type.

42. The method according to claim 40, wherein the information associated with the type of each region is attribute information for each pixel, which indicates if each of pixels that form the region belongs to the first or second type.

43. The method according to claim 40, wherein the information associated with the type of each region is code information indicating the encoding method selected by the selection step.

44. The method according to claim 40, wherein the statistical process calculates the number of pixels, which belong to the first type, of the plurality of pixels that form the region, and
the discrimination step determines that the region is a region of the first type when the number of pixels which belong to the first type exceeds a predetermined threshold value.

45. The method according to claim 37, wherein the encoding method specifies encoding coefficients used upon compressing image data.

46. The method according to claim 45, wherein the encoding coefficients correspond to a quantization matrix used upon compressing image data.

47. The method according to claim 37, further comprising the forming step of forming a data structure which includes at least first compressed data obtained in the first compression step, and second compressed data obtained in the second compression step.

48. The method according to claim 47, wherein the forming step includes the step of storing the second compressed data obtained in the second compression step in a header field of the first compressed data obtained in the first compression step.

49. The method according to claim 38, wherein the input step comprises the PDL interpretation step of interpreting PDL commands described in a page description language, and
the discrimination step includes the step of discriminating based on the PDL commands interpreted in the PDL interpretation step if the region is a non-natural image region.

50. The method according to claim 49, wherein the discrimination step includes the step of determining based on the type of PDL command that a region consisting of character pixels, vector pixels, or graphic pixels is the non-natural image region.

51. The method according to claim 37, wherein the region is compressed using discrete cosine transformation in the first compression step, and
the information associated with the type of region is compressed using runlength encoding in the second compression step.

52. The method according to claim 47, further comprising the sending step of sending the data structure formed in the forming step.

53. The method according to claim 52, wherein the sending step is implemented via an interface used to establish connection to a wireless or wired channel.

54. The method according to claim 53, further comprising the sending control step of controlling sending of the first compressed data in accordance with a communication partner.

55. The method according to claim 53, further comprising:
the partner discrimination step of discriminating if a communication partner is compatible to an encoding method of said image encoding method; and
the instruction step of instructing, only when a compatible state of the communication partner is affirmed in the partner discrimination step, to execute a compression process in the first and second compression steps.

56. The method according to claim 53, further comprising:
the partner discrimination step of discriminating if a communication partner is compatible to an encoding method of said image encoding method; and
the third compression step of compressing, when a compatible state of the communication partner is negated in the partner discrimination step, the image data by an encoding method with which the partner can decode the compressed image data.

57. An image decoding method for decoding encoded data, which is obtained by encoding a plurality of regions that form image data as units, to obtain the image data, comprising:
the storage step of storing the encoded data;
the first decoding step of decoding the encoded data stored in the storage step to obtain information associated with a type of region to be decoded;
the discrimination step of discriminating, based on the information associated with the type of region decoded in the first decoding step, if the region is a region of a first type, a quality of which becomes not more than a predetermined quality if the region is compressed at a predetermined compression ratio, or is a region of a second type, a quality of which exceeds the predetermined quality if the region is compressed at the predetermined compression ratio;
the selection step of selecting a decoding method used to decode the region on the basis of the information associated with the type of each region discriminated in the discrimination step; and
the second decoding step of decoding the region by the decoding method selected in the selection step.

58. The method according to claim 57, wherein the region of the first type is a region associated with a non-natural image, and the region of the second type is a region of a natural image.

59. The method according to claim 58, wherein the non-natural image is an artificial image represented by a character, thin line, print halftone dots, or computer graphics, and the natural image is a photo image.

60. The method according to claim 58, wherein the discrimination step includes the step of discriminating if each of a plurality of pixels, which form the region, belongs to the first or second type, executing a statistical process for each region, and determining based on a statistical amount obtained by the statistical process if the region belongs to the first or second type.

61. The method according to claim 60, wherein the information associated with the type of each region is attribute information for each region, which indicates if the region belongs to the first or second type.

62. The method according to claim 60, wherein the information associated with the type of each region is attribute information for each pixel, which indicates if each of pixels that form the region belongs to the first or second type.

63. The method according to claim 60, wherein the information associated with the type of each region is code information indicating an encoding method of the region.

64. The method according to claim 60, wherein the information associated with the type of region is information associated with a PDL command.

65. The method according to claim 60, wherein the statistical process calculates the number of pixels, which belong to the first type, of the plurality of pixels that form the region, and
the discrimination step includes the step of determining that the region is a region of the first type when the number of pixels which belong to the first type exceeds a predetermined threshold value.

66. The method according to claim 57, wherein the selection step includes the step of specifying encoding coefficients used upon compressing image data, and selecting decoding coefficients corresponding to the encoding coefficients.

67. The method according to claim 66, wherein the encoding coefficients correspond to a quantization matrix used upon compressing image data.

68. The method according to claim 57, wherein the encoded data is a data structure which includes at least first compressed data obtained by compressing the region, and second compressed data obtained by compressing the information associated with the type of region.

69. The method according to claim 68, wherein the encoded data comprises the second compressed data as a header of the first compressed data.

70. The method according to claim 57, wherein the information associated with the type of region is decoded using runlength coding in the first decoding step, and
the region is decoded using discrete cosine transformation in the second decoding step.

71. The method according to claim 57, further comprising the reception step of receiving the data structure.

72. The method according to claim 71, wherein the reception step includes the step of receiving the data structure via an interface used to establish connection to a wireless or wired channel.

73. A program for making a computer execute an image encoding method of claim 37.

74. A program for making a computer execute an image decoding method of claim 57.

75. The apparatus according to claim 4, wherein the information associated with the type of region is the number of pixels which belong to the first type in the region.

76. The apparatus according to claim 4, wherein the information associated with the type of region is the number of pixels which belong to the second type in the region.

77. The apparatus according to claim 4, wherein the information associated with the type of region is a ratio between the number of pixels which belong to the first type and the number of pixels which belong to the second type in the region.

78. The apparatus according to claim 75, wherein said selection means selects the encoding method on the basis of f(x) as a function of information x associated with the type of region.

79. The apparatus according to claim 76, wherein said selection means selects the encoding method on the basis of f(x) as a function of information x associated with the type of region.

80. An image encoding apparatus comprising:
input means for inputting image data;
discrimination means for segmenting the image data input from said input means into a plurality of regions, and discriminating a ratio of regions each having a predetermined nature to the image data;
selection means for selecting an encoding method used to compress the region on the basis of a discrimination result obtained by said discrimination means;
first compression means for compressing the region by the encoding method selected by said selection means; and
second compression means for compressing information which helps specify the encoding method used by said first compression means.

81. The apparatus according to claim 80, wherein said discrimination means comprises:
first discrimination means for discriminating if each of pixels which form the region has the predetermined nature;
first calculation means for calculating the number of pixels affirmed by said first discrimination means;
second discrimination means for discriminating, for each region, if the number of pixels calculated by said first calculation means exceeds a predetermined threshold value; and
second calculation means for calculating the number of regions affirmed by said second discrimination means, and
said selection means selects the encoding method on the basis of the number of regions calculated by said second calculation means.

82. The apparatus according to claim 81, wherein the predetermined nature is a nature unique to a non-natural image.

83. The apparatus according to claim 82, wherein said discrimination means further comprises third calculation means for calculating a ratio of the number of regions calculated by said second calculation means to a total number of regions included in the image data, and
said selection means selects the encoding method for each region on the basis of the ratio calculated by said third calculation means.

84. The apparatus according to claim 83, wherein said selection means selects a first encoding method to be applied to the regions affirmed by said second discrimination means and a second encoding method to be applied to the regions negated by said second discrimination means on the basis of the ratio calculated by said third calculation means.

85. The apparatus according to claim 84, wherein said selection means selects the encoding method using a function f(x) which represents encoding coefficients when the ratio is x.

86. The apparatus according to claim 85, wherein the function f(x) has a nature of increasing a compression ratio of encoding when a ratio of a natural image is high, and of decreasing the compression ratio of encoding when a ratio of a non-natural image is high.

87. The apparatus according to claim 15, wherein said first compression means compresses the region using discrete cosine transformation, and
said second compression means compresses the information associated with the type of region using runlength encoding.

88. The apparatus according to claim 34, wherein said first decoding means decodes the information associated with the type of region using runlength coding, and said second decoding means decodes the region using discrete cosine transformation.

89. An image encoding apparatus comprising:
determination means for determining an image format of an input image;
attribute discrimination means for discriminating an attribute of the image;
quantization coefficient selection means for selecting quantization coefficients used to encode the image on the basis of the attribute discriminated by said attribute discrimination means, and the image format determined by said determination means; and
encoding means for encoding the image on the basis of the quantization coefficients selected by said quantization coefficient selection means.

90. The apparatus according to claim 89, wherein said attribute discrimination means discriminates the attribute for each predetermined region of the image, and
said quantization coefficient selection means selects the quantization coefficients for each predetermined region.

91. The apparatus according to claim 89, wherein the image format is an extension.

92. The apparatus according to claim 89, wherein said encoding means encodes by JPEG.

93. The apparatus according to claim 89, wherein said apparatus can communicate with a plurality of apparatuses via a network.

94. An image decoding apparatus for decoding encoded data, which is obtained by encoding an image with a predetermined image format, and information associated with an attribute of the image, to obtain the image, comprising:
first decoding means for decoding the encoded data to obtain the information associated with the attribute of the image;
attribute discrimination means for discriminating an attribute of the image on the basis of the information decoded by said first decoding means;
dequantization coefficient selection means for reading out the image format of the image, and selecting dequantization coefficients used to decode the encoded data to obtain the image on the basis of the image format and the attribute of the image discriminated by said attribute discrimination means; and
second decoding means for decoding the image on the basis of the dequantization coefficients selected by said dequantization coefficient selection means.

95. The apparatus according to claim 94, wherein said attribute discrimination means discriminates the attribute for each predetermined region of the image, and
said dequantization coefficient selection means selects the dequantization coefficients for each predetermined region.

96. The apparatus according to claim 94, wherein the image format is an extension.

97. An image encoding method comprising:
the determination step of determining a type of image format of an input image;
the attribute discrimination step of discriminating an attribute of the image;
the quantization coefficient selection step of selecting quantization coefficients used to encode the image on the basis of the attribute discriminated in the attribute discrimination step, and the type of image format determined in the determination step; and
the encoding step of encoding the image on the basis of the quantization coefficients selected in the quantization coefficient selection step.

98. The method according to claim 97, wherein the attribute discrimination step includes the step of discriminating the attribute for each predetermined region of the image, and
the quantization coefficient selection step includes the step of selecting the quantization coefficients for each predetermined region.

99. The method according to claim 97, wherein the image format is an extension.

100. The method according to claim 97, wherein the encoding step includes the step of encoding by JPEG.

101. The method according to claim 97, wherein communications with a plurality of apparatuses can be made via a network.

102. An image decoding method for decoding encoded data, which is obtained by encoding an image with a predetermined image format, and information associated with an attribute of the image, to obtain the image, comprising:
the first decoding step of decoding the encoded data to obtain the information associated with the attribute of the image;
the attribute discrimination step of discriminating an attribute of the image on the basis of the information decoded in the first decoding step;
the dequantization coefficient selection step of reading out the image format of the image, and selecting dequantization coefficients used to decode the encoded data to obtain the image on the basis of the image format and the attribute of the image discriminated in the attribute discrimination step; and
the second decoding step of decoding the image on the basis of the dequantization coefficients selected in the dequantization coefficient selection step.

103. The method according to claim 102, wherein the attribute discrimination step includes the step of discriminating the attribute for each predetermined region of the image, and
the dequantization coefficient selection step includes the step of selecting the dequantization coefficients for each predetermined region.

104. The method according to claim 102, wherein the image format is an extension.

105. A storage medium storing a control program for making a computer implement an image encoding method of claim 97.

106. A control program for making a computer implement an image encoding method of claim 97.

107. A storage medium storing a control program for making a computer implement an image decoding method of claim 102.

108. A control program for making a computer implement an image decoding method of claim 102.
